(19) United States
(12) Patent Application Publication
(10) Pub. No.: US 2010/0159383 A1
(43) Pub. Date: Jun. 24, 2010

(54) METHOD FOR PRODUCING COLOR PRINT

(75) Inventors: Shinya OBARA, Tokyo (JP); Shiro HIRANO, Tokyo (JP); Natsuko KUSAKA, Tokyo (JP); Hidehito HARUKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/640,144

(22) Filed: Dec. 17, 2009

(30) Foreign Application Priority Data
Dec. 24, 2008 (JP) 2008327260

(51) Int. Cl. G03G 13/20; G03G 15/01

(52) U.S. Cl. 430/124.1; 399/223

(57) ABSTRACT

The method for manufacturing a color print by an electrophotographic image forming process employs forming toner images by non-contact developing electrostatic latent images on electrostatic latent image holding members in developing devices. For each color, cyan, magenta and yellow, there is a separate electrostatic latent image, a separate electrostatic latent image holding member and a separate developing device. In each developing device the holding member is arranged in a non-contact position with respect to the electrostatic latent image holding member at a development portion. The non-contact developing is carried out by flying the toner from the toner holding member to the electrostatic latent image holding member. The cyan toner exhibits a maximum chroma at lightness L*_{C} of from 53-70.

### CROSS REFERENCE TO RELATED APPLICATIONS

This application is based on Japanese Patent Application No. 2008-327260 filed on Dec. 24, 2008 with Japan Patent Office, the entire content of which is hereby incorporated by reference.

### TECHNICAL FIELD

The present invention relates to a method for producing a color print using an image forming method of an electrophotographic method. In particular, the present invention relates to a method for producing a color print, in which an electrostatic latent image formed on a photoreceptor is developed with a non-contact developing method.

### BACKGROUND

In addition to an office application of a conventional copying apparatus or printer, there has been appeared an instrument called a “digital printing press” for the printing business in these days as an image forming apparatus using an electro photographic method. The background of the appearance of the digital printing press is as follows. In the commercial printing field, there is required to print a various kind of printed matters at a short period of delivery time, and there is a situation in which the field of the digital printing press which can create a printing matter without making a plate has expanded quickly. The distinctive feature of a digital printing press is that it is not necessary to make a plate which is needed to make for the conventional printing press, as mentioned above. In addition to that, there is also a digital printing press which is provided with a new technology, such as enabling to perform continuously printing, with changing information including the name of a place or a name. In the digital printing press, the apparatus suitable for the acceptance of an order of a small lot unit has been widely developed. Thus described, the digital printing does not need to make a plate and it has a new function such as to make it possible to output variable information of a small lot unit. From these reasons, this apparatus has come to attract attention in the commercial printing field as an alternative apparatus of the offset press which has been mainly used in this field.

In the commercial printing field, the printed image itself is positioned as a commercial product. Therefore, high quality is demanded also for the printed image output by the digital printing press. From such a background, investigation of new technology is advanced also in the field of toner technology. For example, there is a development of the toner called a high chroma toner which can form the toner image exhibiting image color more vivid than before (for example, refer to Patent Document 1).

In addition to the above-mentioned improvement in image color, the needs of improvement of picture quality of the electrophotographic picture image in the commercial printing field were turned also to improvement of gradation or evenness of an image. Vivid image color, rich gradation and high evenness are searched for especially in the halftone color portion represented by the halftone imaging area. The needs of realizing production of the printing matter of the image quality which is rich in spatial perception and sense of presence has been growing. The writing accuracy technology by the short wavelength light exposure light called “Blu-ray” whose emission wave length is 350 nm-500 nm has been improved. It seems that the needs which faithfully reproduce a detailed dot latent image with toner were further raised by using this “Blu-ray” technology.

As a technology of realizing improvement of an image quality of a halftone image, a so-called non-contact developing method is efficient. In this method, charged toner particles are fed to an electrostatic latent image holding member (a photoreceptor) by making fly the charged toner particles from a toner holding member (a developing sleeve) (for example, refer to Patent Document 2). In order to provide the surface of the photoreceptor with the charged toner particles on the developing sleeve, there is known a method called a hybrid development method as one of the efficient methods. In this method, the charged toner particles on the developing sleeve are fed to the surface of the photoreceptor via a conveying and feeding roller (for example, refer to Patent Document 3). However, these technologies aimed at improvement of image quality by paying attention to thin layer formation of the toner on a developing sleeve or on a transfer feed roller, and improvement of image quality by paying attention to the characteristics of the toner itself was not examined. Therefore, the halftone image exhibiting a high image quality which is requested in the commercial printing field was not necessarily able to be formed only by using these developing devices. Specifically, the following problems were required to be resolved: evenness and granularity of a halftone image; and fluctuation of density at an edge portion in a solid image which has been a problem for a long time in the image formation of the electrophotography, i.e., the excess of density at an edge part (edge effect), the decrease of density at an edge part of a specific direction, and a small deficit of an edge (edge deficit).
Patent Document 1: Japanese patent application publication (JP-A) No. 2008-176311
Patent Document 2: JP-A No. 2008-318011
Patent Document 3: JP-A No. 2008-40210

### SUMMARY

An object of the present invention to provide a method for manufacturing a color print using an electrophotographic method which enable to form a half tone image exhibiting vivid chroma, excellent gradation and high evenness. More specifically, an object of the present invention is to provide a method for manufacturing a color print exhibiting vivid chroma, excellent granularity, high evenness and sharp edge when a toner image is formed using a specific cyan toner and a specific magenta toner.

It was found out that the above-mentioned object of the present invention can be resolved by any one of the following embodiments.

1. One of the embodiments of the present invention

a method for manufacturing a color print by an electrophotographic image forming process comprising the steps of:

forming a cyan toner image by non-contact developing a 1st electrostatic latent image on a 1st electrostatic latent image holding member with a cyan toner contained in a 1st developing device,

forming a magenta toner image by non-contact developing a 2nd electrostatic latent image on a 2nd electrostatic latent image holding member with a magenta toner contained in a 2nd developing device and,

forming a yellow toner image by non-contact developing a 3rd electrostatic latent image on a 3rd electrostatic latent image holding member with a yellow toner contained in a 3rd developing device,

wherein each of the developing devices has a toner holding member arranged in a non-contact position with each of the electrostatic latent image holding members at a development portion,

the non-contact developing is carried out by supplying the toner held on the toner holding member to the electrostatic latent image holding member with flying and, the cyan toner satisfies the following condition that a cyan image formed with only the cyan toner exhibits a maximum chroma at lightness L*_{C} of from 53-70.

2. The method for manufacturing a color print of claim 1,

wherein the magenta toner satisfies the following condition that a magenta image formed with only the magenta toner exhibits a maximum chroma at lightness L*_{M} of from 35-51.

3. The method for manufacturing a color print of claim 1,

wherein the non-contact developing method is a hybrid developing method.

By the present invention, it was achieved to provide a method for forming a color image using an electrophotographic method which enables to form a half tone image exhibiting vivid chroma, excellent gradation and high evenness. More specifically, by the present invention, it was achieved to provide a method for forming a color print exhibiting vivid chroma, excellent granularity, high evenness and sharp edge when a toner image is formed using a specific cyan toner and a specific magenta toner. As described-above, the present invention enables to provide a method for manufacturing a color print containing a half tone image rich in spatial perception and sense of presence with vivid image color, rich gradation and high evenness.

The present invention can emphasize the above-mentioned effect further, when a specific cyan toner is used together with a specific magenta toner.

### BRIEF DESCRIPTION OF THE DRAWINGS

FIG. 1 is a schematic view showing an example of a tandem type full-color image forming apparatus in which image formation of a two-component development system is feasible.

FIG. 2 is a cross-sectional structural view showing an example of a developing device using a non-contact developing method.

FIG. 3 is a cross-sectional structural view showing a developing device using a hybrid developing method.

### DESCRIPTION OF THE PREFERRED EMBODIMENTS

The present invention relates to a method for producing a color print using a developing device provided with a cyan toner, a magenta toner and a yellow toner, and the developing device has a structure in which a toner holding member and an electrostatic latent image holding member are located in a non-contact state at a development portion.

The present invention will be specifically described in the following.

In a method for forming a color image of the present invention, a specific cyan toner is employed. The specific cyan toner satisfies the condition that a cyan image formed with only the cyan toner exhibits a maximum chroma when lightness L*_{C} of from 53-70. In the present invention, it is preferable to employ the cyan toner satisfying the above condition. And at the same time, it is preferable to employ the magenta toner satisfies the condition that a magenta image formed with only the magenta toner achieves the maximum chroma when lightness L*_{M} of the magenta image is in the range of 35 to 51.

Here, lightness L* of a monochromatic toner image and a maximum chroma according to the present invention will be described.

Lightness L* of each monochromatic toner image is defined by L*a*b* color system. “L*a*b* color system” described herein is a means employed to represent color as a numeric value. Colors can be numerically expressed by the values of three axes of L*, a* and b*. L* is the coordinate in the z-axis direction to expresses lightness, and “lightness” designates a relative lightness of a color. The plus (+) direction of Z axis is a direction of increasing the lightness, and the minus (−) direction is a direction of decreasing the lightness, i.e., a direction of becoming dark.

While, a* and b* are coordinates of x-axis and y-axis, respectively, to express “hue” and “chroma” through both of them. In addition, the plus (+) direction of x-axis represented by a* on the x-axis-y-axis plane is a magenta direction, the minus (−) direction of x-axis is a green direction. The plus (+) direction of y-axis represented by b* is a yellow direction, and the minus (−) direction of y-axis is a blue direction.

“Hue” refers to color such as red, yellow, green, blue, violet or the like. “Chroma” refers to a color brightness degree defined by the following equation (1).

Chroma C*=[(a*)²+(b*)²]^{1/2} Equation (1)

Chroma C* is a distance of a certain coordinate point (a*, b*) from origin O on the x-axis-y-axis plane as is shown by the aforesaid Equation (1).

Further, in L*a*b* color system, color tone can be described by the concept such as a hue angle. Herein, hue angle h means an angle made between a half line connecting a certain coordinate point (a, b) to origin O on the x-axis-y-axis plane showing the relationship of hue and chroma when lightness takes a certain value, and a line extending in the plus (+) direction (red direction) of x-axis in the counter-clockwise direction from the plus (+) direction (red direction) of x-axis, and is calculated by the following Equation (2).

Hue angle h=tan⁻¹(b*/a*) Equation (2)

“The maximum chroma” of the toner of the present invention is defined as follows.

Generally, when image formation is done using a toner containing a sufficient amount of colorant, chroma of the toner image will increase almost proportionally with the increase of a toner adhesion amount on the transfer paper. However, when the toner adhesion amount exceeds a certain level, chroma does not increase any more even though the adhesion amount is increased, to such an extent it becomes sluggish, and is eventually to be lowered. When the toner adhesion amount is increased, chroma at a turning point from the increase to the decrease is defined as a maximum chroma in this case.

The amount of toner adhesion can be measured as follows: to measure the weight of an unfixed patch toner image of 20 mm×50 mm including the transferring paper; to blow off the unfixed image transferred on the transfer paper using an air gun to an extent that the image cannot be observed with naked eyes; to measure the remained transfer paper and to obtain the amount of toner adhesion; and to divide the weight of the blown toner by the weight of the transfer paper so as to obtain the toner adhesion amount per unit area.

Here, as the transfer paper (or called as a recording paper) used for measuring the amount of toner adhesion, a paper having a weight of 128 g/m² and a lightness of 80 can be employed. For example, “POD GLOSS COAT” (made of Oji Paper Co. Ltd.) can be cited.

When the toner adhesion amount is kept proportional to chroma, the chroma obtained by the image having the maximum toner adhesion on a transfer paper, which is achieved by the setting condition of the image forming apparatus, is defined as a maximum chroma in this case.

L*a*b* to determine chroma C* and hue h is specifically measured by a spectrophotometer “Gretag Macbeth Spectrolino” (produced by Gretag Macbeth Co. Ltd.). Similarly to the measurement of reflection spectra, the measurement is carried out with the following conditions: a D65 light source as a light source, a reflection measuring aperture diameter of 4 mm, 10 nm intervals in the wavelength range to be measured, a viewing angle (observer) of 2°, and a white tile for adjustment of the base line.

The relationship between the toner adhesion amount and chroma can be correlated by measuring the chroma of the toner image formed with each toner adhesion amount, the image being printed based on gradation evaluation patch of “ECI-2002 image data” (Random Layout) recommended by ECI (European Color Initiative).

The toner fixing condition used to measure chroma and lightness of the toner image is the standard fixing condition for an image forming apparatus used in the present invention. Further, glossiness of the toner image used to measure chroma and lightness of the toner image is a value measured with a measurement angle 75 degree using Gloss Meter (manufactured by Murakami Color Research Laboratory Co., Ltd.), and the glossiness of a toner image having a gloss degree of at least 10 is measured.

Next, lightness L*_{C} of the cyan toner used in the present invention will be described. More specifically, lightness L*_{C} when the toner image formed only with the cyan toner takes the maximum chroma will be described. The cyan toner of the present invention is required to achieve the maximum chroma when lightness L*_{C} of the toner image formed with only cyan toner is in the range of 53 to 70. In the present invention, the toner image formed with only the cyan toner preferably has a maximum chroma C*_{C} of 50-80 in view of the secondary color formed with the cyan toner, that is, color development of green and blue. Herein, the definition of the maximum chroma of a cyan toner monochromatic image is defined as follows.

(1) When a content of a colorant in the toner is arranged to be high, chroma increases almost proportionally with increase of a toner adhesion amount, but when chroma exceeds a certain level, chroma does not increase any more even though the adhesion amount is increased, to such an extent it becomes sluggish, and is eventually to be lowered. When the toner adhesion amount is increased, chroma at a tuning point from the increase to the decrease is defined as the maximum chroma in this case.
(2) When the toner adhesion amount is proportional to chroma, chroma corresponding to the maximum toner adhesion amount to a transfer paper, which can be controlled by the image forming apparatus, is defined as the maximum chroma in this case.

In addition, the maximum chroma of cyan is one measured at a hue angle of 212°. In this case, as to lightness of a cyan image, lightness L*_{C} is arranged to be in the range of 53-70 when a cyan toner monochromatic image exhibits the maximum chroma, and lightness L*_{C} is arranged to be preferably in the range of 57-67 when a cyan toner monochromatic image exhibits the maximum chroma.

Next, lightness L*_{M} when the toner image formed only with the magenta toner takes the maximum chroma will be described. In the present invention, it is preferable to employ the cyan toner achieving the maximum chroma when lightness L*_{C} of the toner image formed with only the cyan toner in the above-described range. And at the same time, is preferable to employ the magenta toner achieving the maximum chroma when lightness L*_{M} of the toner image formed with only the magenta toner is in the range of 35 to 51. In the present invention, the toner image formed with only the magenta toner preferably has a maximum chroma C*_{M} of 70-100 in view of the secondary color formed with the magenta toner, that is, color development of blue and red. Herein, the definition of the maximum chroma of a magenta toner monochromatic image is the same definition as described in the cyan toner monochromatic image.

In addition, the maximum chroma of magenta is one measured at a hue angle of 336°. In this case, as to lightness of a magenta image, lightness L′ is preferably arranged to be in the range of 35-51 when a magenta toner monochromatic image exhibits the maximum chroma, and more preferably, lightness L*_{M} is arranged to be in the range of 40-49.

In the present invention, when a toner image formed with only the specific toner exhibits a maximum chroma with lightness in the range of the above-described value, a non-contact developing method can be stably used. One of the most representative non-contact developing methods is a hybrid developing method. The non-contact developing method performs development by making fly the toner particles from the toner layer formed on a development roller onto a photoreceptor which has been formed an electrostatic latent image thereon. When a medium tone image such a halftone image is formed, this method will not produce brush marks formed by a carrier on a surface of an image. In addition, it can be avoided an unnatural final image induced by a local increase of chroma and density caused by increase of toner adhesion amount at an edged portion of the image.

As describe above, the present invention enables to produce a gradation of a halftone image with extremely high precision. At the same time, the present invention enables to reduce the unevenness caused by an edge effect to an extent of non conceivable to human eyes. As a result, a cyan image obtained has become high quality and comfortable to the eyes. Since the amount of the reflected light from the image has become uniform and has been increased, the expansion of the cyan color reproduction range has been achieved.

Next, the specific cyan toner used in the present invention will be described. The specific cyan toner enables to form an image exhibiting a maximum chroma when the image is formed with only the cyan toner and lightness L*_{C} of the image is in the range of 53 to 70.

The method for forming a color print of the present invention uses a so-called non-contact development method. This method performs development of a cyan toner image by making fly the cyan toner particles from the cyan toner layer formed on a development roller (a toner holding member) onto a photoreceptor (an electrostatic latent image holding member) which has been formed an electrostatic latent image thereon. And, when the toner image formed with only the cyan toner exhibits a maximum chroma, lightness L*_{C} of the image is in the range of 53 to 70.

The cyan toner enabling to realize the above-described constitution contains preferably a compound represented by Formulas (I) or (II).

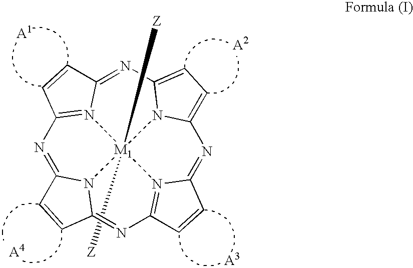

In Formula (I), M¹ represents a center metal atom selected from the group consisting of Si, Ge and Sn. Two Zs each independently represents a hydroxyl group, a chlorine atom, an aryloxy group having 6-18 carbon atoms, an alkoxy group having 1-22 carbon atoms or a group represented by the following Formula (I). Further, A¹, A², A³ and A⁴ each independently represent an atomic group represented by one of (a-1) to (1-18), each forming an aromatic ring which may have an electron-withdrawing group on the aromatic ring.

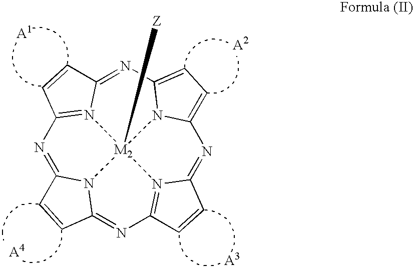

In Formula (II), M² represents a center metal atom of Al or Ga. Z represents a hydroxyl group, a chlorine atom, an aryloxy group having 6-18 carbon atoms, an alkoxy group having 1-22 carbon atoms or a group represented by the following Formula (I). Further, A¹, A², A³ and A⁴ each independently represent an atomic group represented by one of (a-1) to (1-18), each forming an aromatic ring which may have an electron-withdrawing group on the aromatic ring.

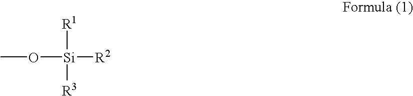

R₁, R₂ and R₃ in Formula (I) each represent an alkyl group having 1-22 carbon atoms, an aryl group having 6-18 carbon atoms, an alkoxy group having 1-22 carbon atoms or an aryloxy group having 6-18 carbon atoms. R₁, R₂ and R₃ may be identical with each other, or may be different from each other.

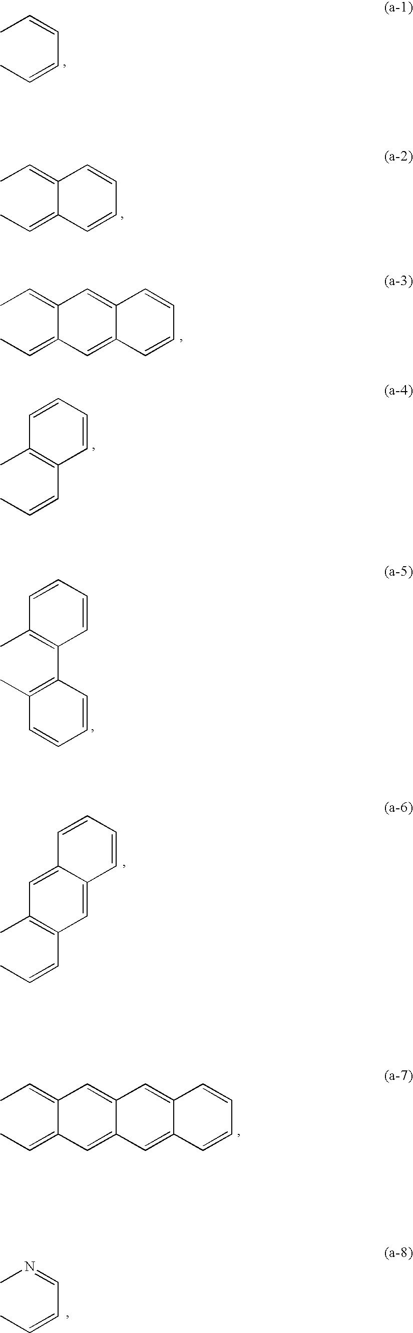

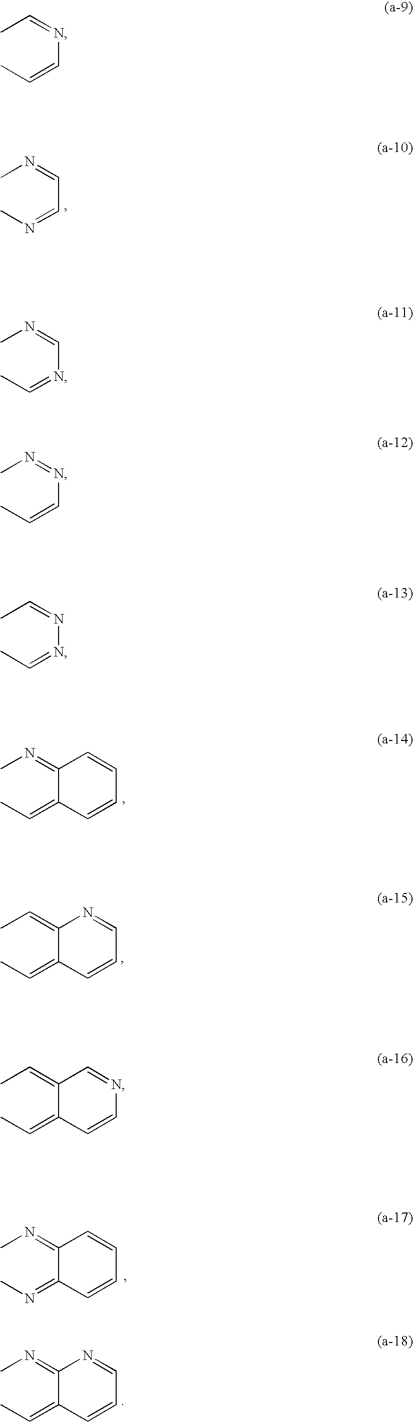

The cyan toner of the present invention may contain a compound represented by Formula (III), in addition to a compound represented by Formulas (I) or (II).

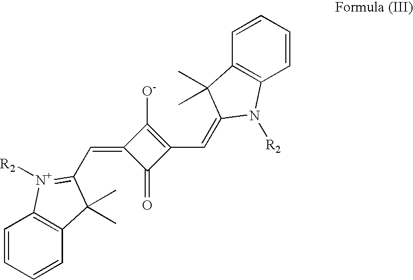

R₂ in Formula (III) represents a hydrogen atom or an organic group.

The colorant for the cyan toner achieving the aforesaid lightness L*_{C} can be obtained from the dispersion containing the compound represented by Formulas (I), (II) or (III) by adjusting the reflection spectrum thereof to satisfy the Formulas (11) to (14). In order to achieve this process, an ordinary skilled person will not need to perform specific trial and error.

In other word, the cyan toner which enables to form a cyan image having the aforesaid lightness L*_{C} can be obtained by preparing a colorant particle dispersion for a cyan toner with the condition that the colorant particle dispersion satisfy the following Formulas (11) to (14) when the reflection spectrum is measured.

4≦|C₄₈₀−C₄₅₀|≦16 Formula (11)

wherein C₄₈₀ represents reflectance (in terms of %) at a wavelength of 480 nm, and C₄₅₀ represents reflectance (in terms of %) at a wavelength of 450 nm.

15≦C₅₅₀−C₅₇₀≦35 Formula (12)

20≦C₅₇₀≦50 Formula (13)

wherein C₅₅₀ represents reflectance (in terms of %) at a wavelength of 550 nm, and C₅₇₀ represents reflectance (in terms of %) at a wavelength of 570 nm.

0≦C₆₂₀+C₆₅₀≦30 Formula (14)

wherein C₆₂₀ represents reflectance (in terms of %) at a wavelength of 620 nm, and C₆₅₀ represents reflectance (in terms of %) at a wavelength of 650 nm.

Here, the reflection spectrum of a cyan toner monochromatic image can be measured with a spectrophotometer “Gretag Macbeth Spectrolino” (produced by Gretag Macbeth Co. Ltd.). The employed measuring conditions are as follows: a D65 light source as a light source, a reflection measuring aperture diameter of 4 mm, 10 nm intervals in the wavelength range to be measured, a viewing angle (observer) of 2°, and a white tile for adjustment of the base line.

The monochromatic toner image used for measurement of a reflection spectrum is formed on a transfer paper having a weight of 128 g/m² and a lightness of 93. For example, by using “POD GLOSS COAT” (made of Oji Paper Co. Ltd.), the measurement is done on a portion of the image having a glossiness of 10 or more. The measurement of glossiness is carried out with Gloss Meter (manufactured by Murakami Color Research Laboratory Co., Ltd.). When a toner image is formed, the toner fixing is done under the standard fixing condition for the image forming apparatus used in the present invention.

Preferred embodiments of a cyan toner which realizes the aforesaid lightness L*_{C} are cited as: one which contains a compound represented by Formulas (I) or (II) as a colorant; and one which further contains a compound represented by Formulas (III) in addition to a compound represented by Formulas (I) or (II). Among them, a compound represented by Formula (I) is preferably used. A compound represented by Formula (I) contains a metal atom M¹ which is located in a center of the ring structure (hereafter, this metal atom is also called as a center metal atom) and is selected from a Si atom, a Ge atom or a Sn atom. Among these, a compound having a Si atom as a center metal atom is specifically preferred. Further, a compound represented by Formula (II) contains either an Al atom or a Ga atom as a center metal atom M².

Z in a compound represented by Formulas (I) or (II) represents, as described above, a hydroxyl group, a chlorine atom, an aryloxy group having 6-18 carbon atoms, an alkoxy group having 1-22 carbon atoms or a group represented by the aforesaid Formula (I). And R₁, R₂ and R₃ in Formula (I) each represent an alkyl group having 1-22 carbon atoms, an aryl group having 6-18 carbon atoms, an alkoxy group having 1-22 carbon atoms or an aryloxy group having 6-18 carbon atoms. Here, R₁, R₂ and R₃ may be identical with each other, or may be different from each other. The carbon number in these groups is preferably from 1 to 10, and more preferably from 2 to 8. Among these, a chlorine atom, a hydroxyl group, and an alkoxy group having 1-5 carbon atoms are preferable from the viewpoint of achieving thermal stability.

In a compound represented by Formulas (I) or (II), A¹, A², A³ and A⁴ each independently represent an atomic group represented by one of (a-1) to (1-18). The groups represented by A¹, A², A³ and A⁴ each have preferably a bonded structure formed with a ring having a center metal atom via 4 carbon atoms. More definitely, it is preferable that the group is structure (a-1) which forms a benzene ring with a ring having a center metal atom to adjust the color. Further, the groups represented by A¹, A², A³ and A⁴ each have a chlorine atom, a trifluoromethyl group or a nitro group so as to change the color.

A cyan toner preferably used in the present invention may contain a compound represented by Formulas (I) or (II) solely or in combination of two or more compounds. Further, it is preferable that a cyan toner contains a compound represented by Formulas (III) in addition to a compound represented by Formulas (I) or (II). An amount of the above described compounds in the toner is 4 to 12 weight % based on the binder resin in the toner, and more preferably 5 to 9 weight %.

Specific examples of a compound represented by Formula (I) will be shown below, however, a compound represented by Formula (I) usable in the present invention is not limited to them.

TABLE 1

| | Center | Atomic | | Substituent on atomic |
|---|---|---|---|---|
| Compound | metal | groups (A¹, | | groups |
| no. | atom M¹ | A², A³ and A⁴) | Z | (A¹, A², A³ and A⁴) |
| I-1 | Si | (a-1) | —O—Si(CH₂CH₃)₃ | |
| I-2 | Si | (a-1) | —OH | |
| I-3 | Si | (a-1) | —O—Si(CH₂CH₂CH₃)₃ | |
| I-4 | Si | (a-1) | —O—Si(CH₃)₃ | |
| I-5 | Si | (a-1) | —O—Si(CH₂CH₂CH₂CH₂CH₂CH₂CH₂CH₃)(CH₃)₂ | |
| I-6 | Si | (a-1) | —O—Si(t-C₄H₉)₃ | |
| I-8 | Si | (a-1) | —O—Si(CH₂CH₃)₃ | 4-Chloro atom |
| I-9 | Si | (a-1) | —O—Si(CH₂CH₃)₃ | 3,4-Dichloro atoms |
| I-10 | Si | (a-1) | —Cl | 4-Trifluoromethyl group |
| I-11 | Si | (a-1) | —O—CH₂CH₂CH₃ | |
| I-12 | Si | (a-1) | —Cl | |
| I-13 | Si | (a-1) | —O—CH₃ | |
| I-14 | Si | (a-1) | —O—CH₂CH₂CH₂CH₃ | |
| I-15 | Si | (a-1) | —O—CH(CH₃)(CH₂)₂CH₃ | |
| I-16 | Sn | (a-1) | —O—(CH₂)₄CH₃ | |
| I-17 | Ge | (a-1) | —O—(CH₂)₄CH₃ | |
| I-18 | Si | (a-1) | —O—(CH₂)₄CH₃ | |
| I-19 | Si | (a-1) | —O—(t-C₄H₉) | |
| I-20 | Si | (a-1) | O—C₆H₅ | |
| I-21 | Si | (a-1) | —O—C(CH₂CH₃)₃ | |

The following compounds are cited as specific examples of a compound represented by Formula (III) which can be used in combination of a compound represented by Formulas (I) or (II).

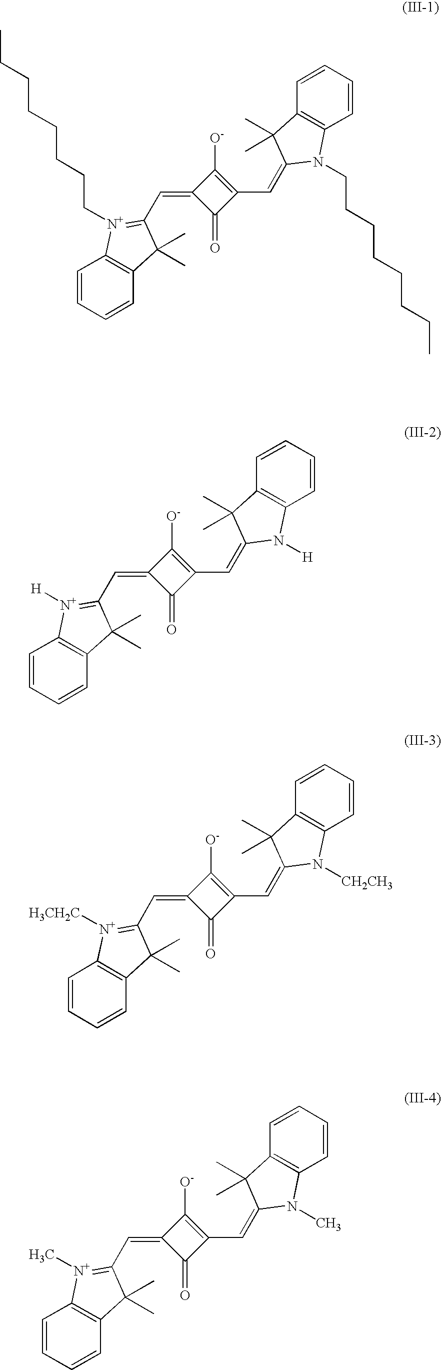

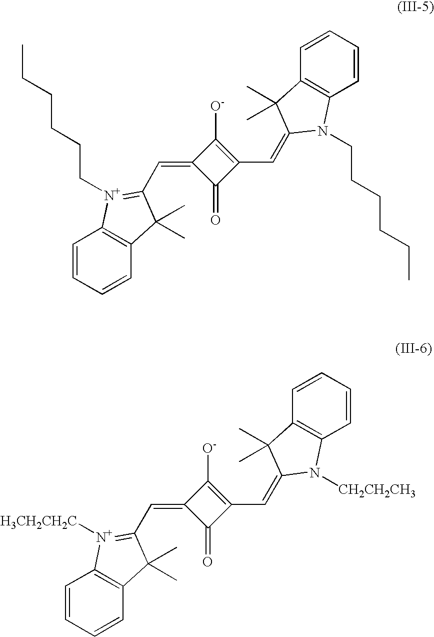

Next, a specific magenta toner will be described. This magenta toner exhibits lightness L*_{M} in the aforesaid range when the toner image is formed with only the magenta toner.

In the present invention, it is preferable to employ the cyan toner achieving the maximum chroma when lightness L*_{C} of the toner image is in the above-described range. And at the same time, it is preferable to employ the magenta toner achieving the maximum chroma when lightness L*_{M} of the toner image formed with only the magenta toner is in the range of 35 to 51.

It is preferable that lightness L*_{M} of the formed toner image is in the range of 35 to 51 when the toner image formed with only the magenta toner exhibits a maximum chroma. The method for forming a color print of the present invention uses a so-called non-contact development method which is represented by a hybrid developing method. This method performs development of a magenta toner image by making fly the magenta toner particles from the magenta toner layer formed on a development roller onto a photoreceptor which has been formed an electrostatic latent image thereon.

The magenta toner enabling to realize the above-described constitution contains preferably a compound represented by Formulas (3), (4) or (5) which will be described later as a colorant.

The colorant for the magenta toner achieving the aforesaid lightness L*_{M} can be obtained by mixing the dispersion containing the following ingredients and by adjusting the reflection spectrum thereof to satisfy the Formulas (21) to (24). In order to achieve this process, an ordinary skilled person will not need to perform specific trial and error.

In other word, the magenta toner which enables to form a magenta image having the aforesaid lightness L*_{M} can be obtained by preparing a colorant particle dispersion for a magenta toner with the condition that the colorant particle dispersion satisfies the following Formulas (21) to (24) when the reflection spectrum is measured.

30≦B₄₅₀−B₅₂₀≦85 Formula (21)

wherein B₄₅₀ represents reflectance (in terms of %) at a wavelength of 450 nm, and B₅₂₀ represents reflectance (in terms of %) at a wavelength of 520 nm.

1≦B₅₃₀−B₅₇₀≦25 Formula (22)

wherein B₅₃₀ represents reflectance (in terms of %) at a wavelength of 530 nm, and B₅₇₀ represents reflectance (in terms of %) at a wavelength of 570 nm.

2≦B₆₇₀−B₆₀₀≦50 Formula (23)

80≦B₆₇₀ Formula (24)

wherein B₆₇₀ represents reflectance (in terms of %) at a wavelength of 670 nm, and B₆₀₀ represents reflectance (in terms of %) at a wavelength of 600 nm.

The measurement of a reflection spectrum of the above-described magenta toner image is done using the same conditions applied for the measurement of a reflection spectrum of the above-described cyan toner image.

The magenta toner exhibiting lightness L*_{M} in the above-described range can be prepared by incorporating the following pigment or dye as a colorant.

Specific examples of the pigment include: C.I. Pigment Red 2, C.I. Pigment Red 3, C.I. Pigment Red 6, C.I. Pigment Red 7, C.I. Pigment Red 9, C.I. Pigment Red 15, C.I. Pigment Red 16, C.I. Pigment Red 48:1, C.I. Pigment Red 48:3, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 208, C.I. Pigment Red 209 and C.I. Pigment Red 222.

Specific examples of the dye include: C.I. Solvent Red 3, C.I. Solvent Red 3, C.I. Solvent Red 14, C.I. Solvent Red 17, C.I. Solvent Red 18, C.I. Solvent Red 22, C.I. Solvent Red 23, C.I. Solvent Red 49, C.I. Solvent Red 51, C.I. Solvent Red 53, C.I. Solvent Red 87, C.I. Solvent Red 3, C.I. Solvent Red 127, C.I. Solvent Red 128, C.I. Solvent Red 131, C.I. Solvent Red 145, C.I. Solvent Red 146, C.I. Solvent Red 149, C.I. Solvent Red 150, C.I. Solvent Red 151, C.I. Solvent Red 152, C.I. Solvent Red 153, C.I. Solvent Red 154, C.I. Solvent Red 155, C.I. Solvent Red 156, C.I. Solvent Red 157, C.I. Solvent Red 158, C.I. Solvent Red 176 and C.I. Solvent Red 179.

The magenta toner exhibiting lightness L*_{M} in the above-described range can also be prepared by incorporating a compound having a structure represented by Formulas (IV) or (V).

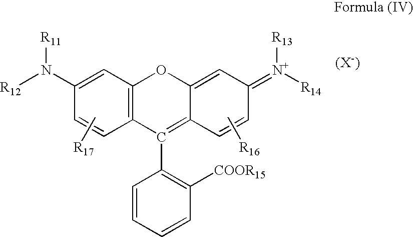

In Formula (IV), R₁₁, R₁₂, R₁₃, R₁₄ and R₁₇ each independently represent a hydrogen atom or an alkyl group having 1 to 4 carbon atoms. R₁₅ and R₁₆ each independently represent a hydrogen atom or an alkyl group having 1 or 2 carbon atoms. m and n each represent an integer of 1 or 2. (X⁻) is a counter anion and represents a chlorine atom or a sulfonic acid compound ion.

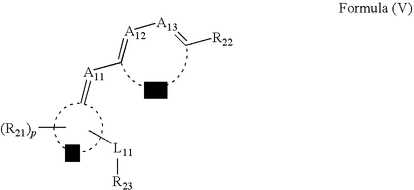

In Formula (V), R₂₁ represents a hydrogen atom or a substituent. R₂₂ represents —NR₂₄ R₂₅ or —OR₂₆. R₂₃ represents a hydroxyl group, an alkoxy group, an aryloxy group, an amino group, an amide group, an alkylsulfonyl group or an arylsulfonyl group. Further, A₁₁ to A₁₁ each independently represent —C R₂₇═ or —N═.

X₁₁ in Formula (V) represents an atomic group necessary to form a 5 or 6 membered aromatic ring or heterocyclic ring. Z₁ represents an atomic group necessary to form a 5 or 6 heterocyclic ring which contains at least one nitrogen atom, and the heterocyclic ring may form a condensed ring with the substituent thereon. R₂₄ through R₂₇ each independently represent a hydrogen atom or a substituent. L₁₁ represents a linking group having 1 or 2 carbon atoms, or L₁₁ represents a part of a ring. L₁₁ may form a 5 or 6 membered ring jointed with R₂₃.

“p” is an integer of 0 to 3.

Specific examples of a compound represented by the aforesaid Formula (IV) used as a preferable colorant for the magenta toner are as follows.

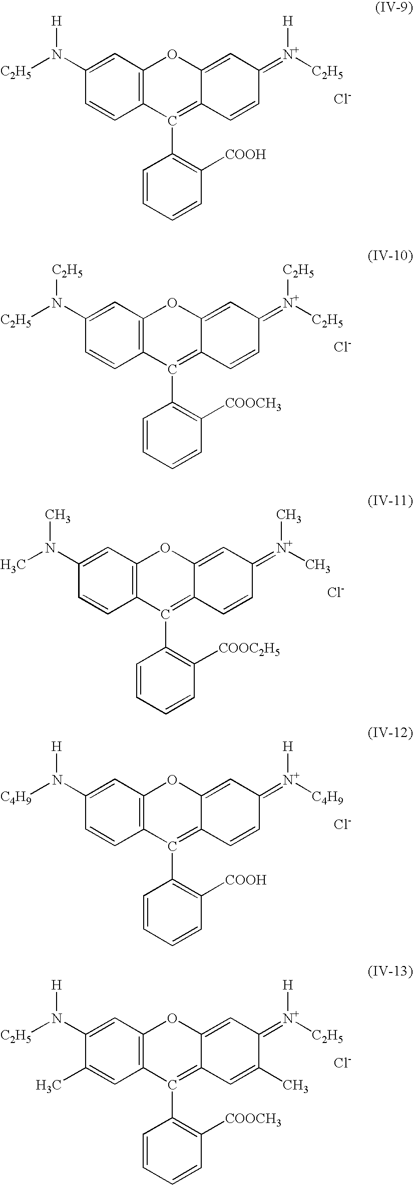

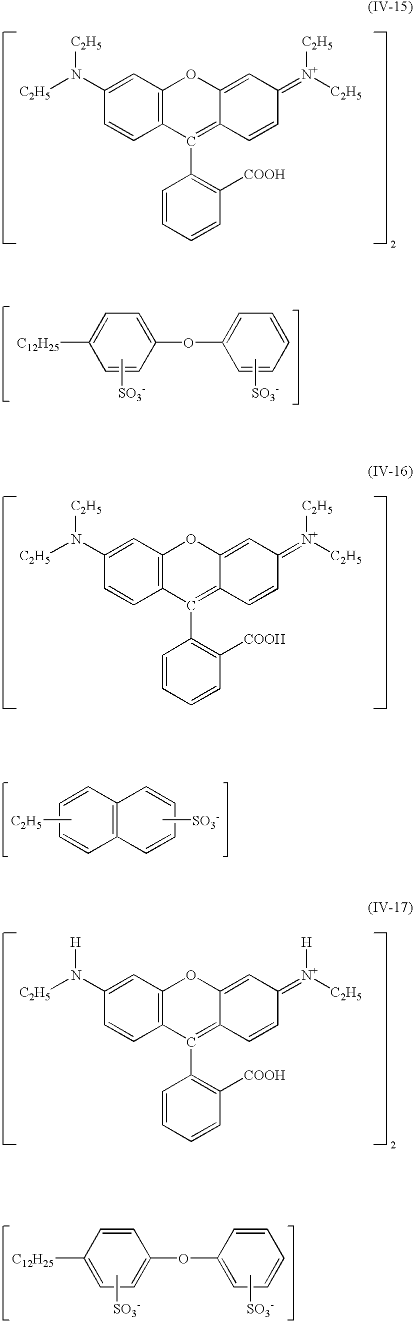

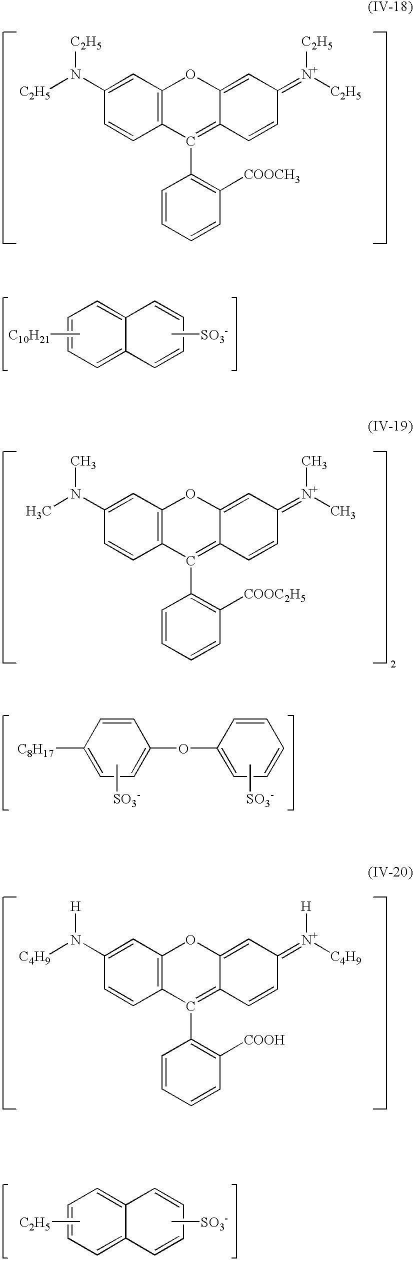

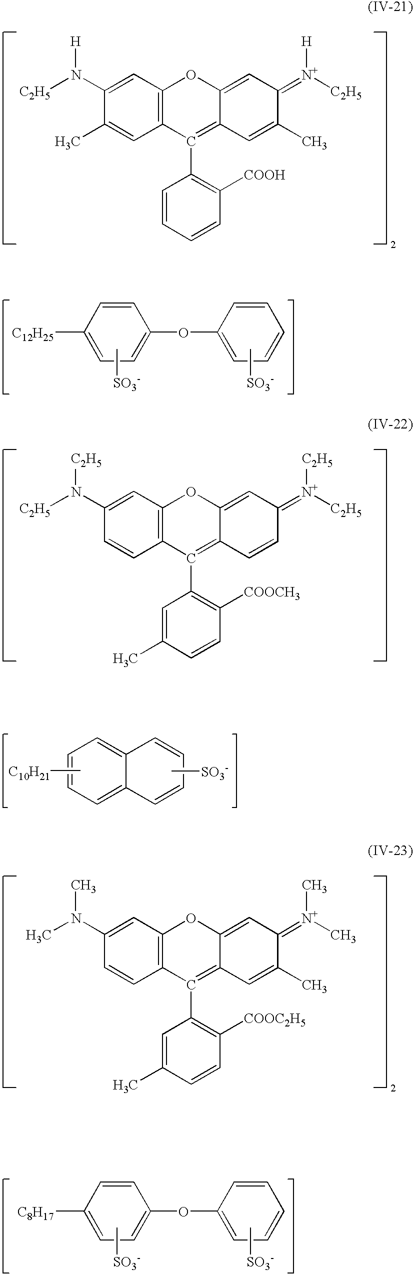

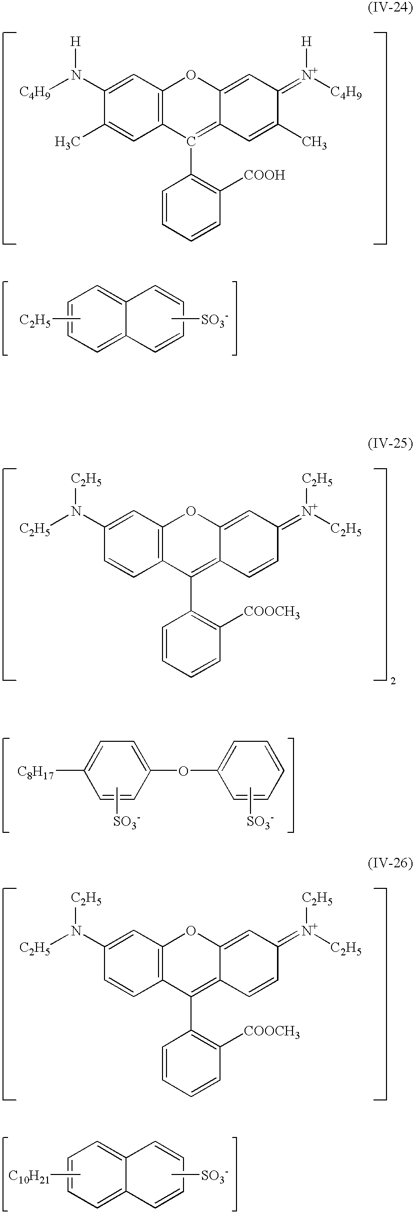

Specific examples of a compound represented by the aforesaid Formula (V) used as a preferable colorant for the magenta toner are as follows.

The content of a magenta colorant in the magenta toner particles is in the range of from 2 to 12 parts by weight, and preferably from 4 to 10 parts by weight with respect to 100 parts by weight of the magenta toner particles.

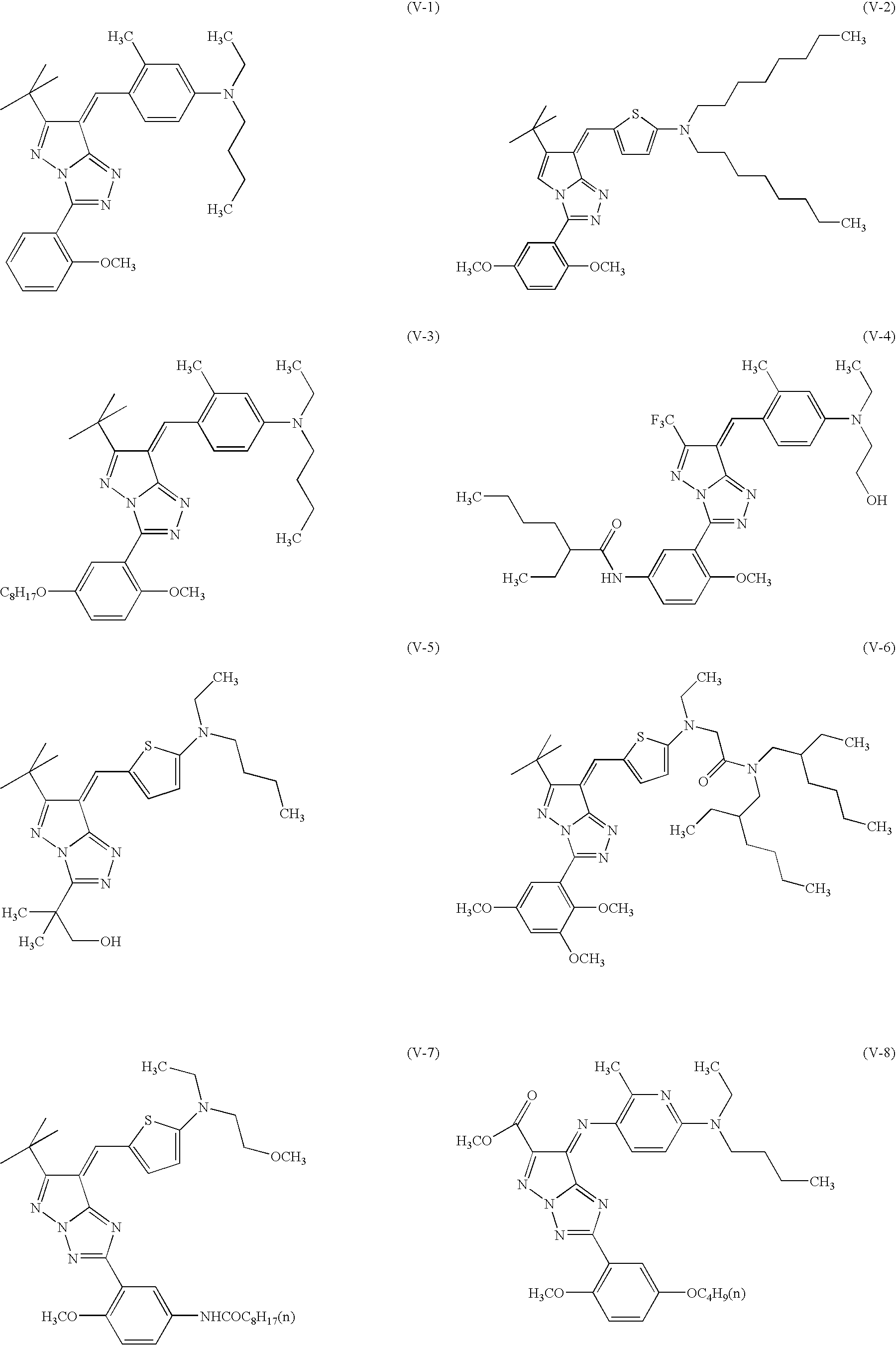

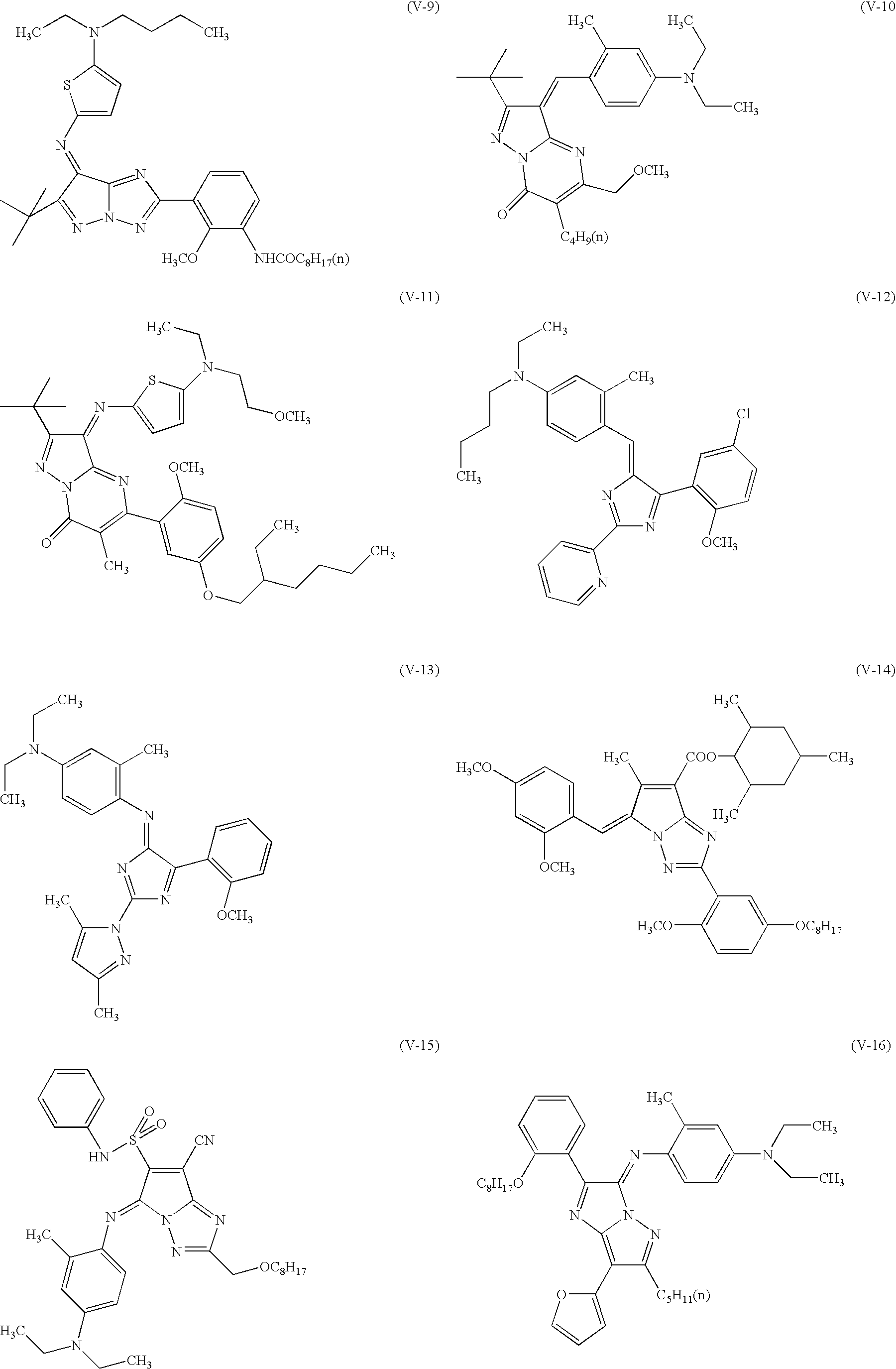

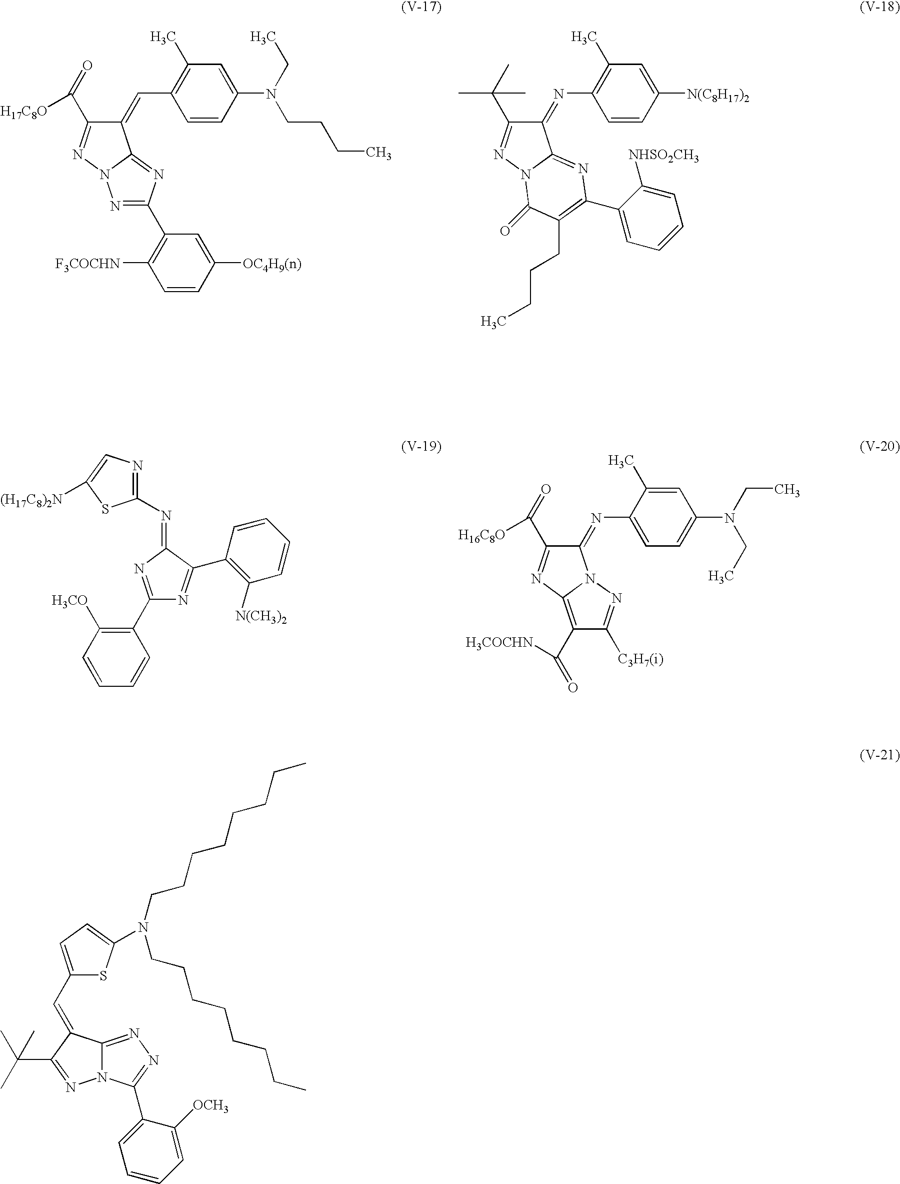

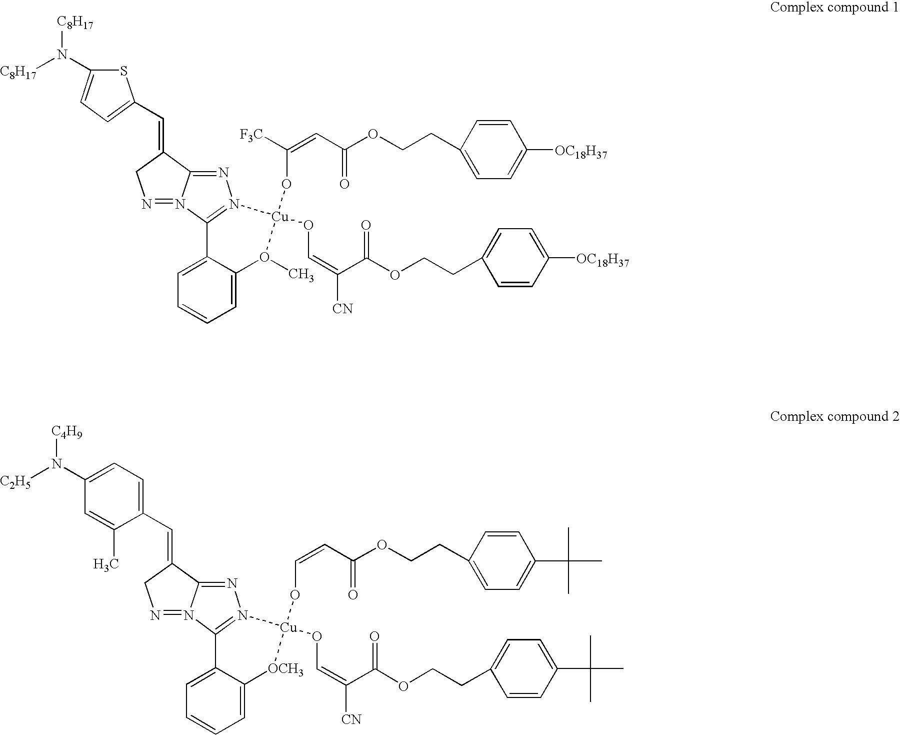

Then, a yellow toner used for the present invention will be described. The present invention produces a color print employing a yellow toner in combination of the aforesaid cyan toner and magenta toner. A preferred embodiment of the yellow toner used in the present invention is a toner containing a colorant which will be described later. It is preferable that the colorant of the yellow toner satisfy the following Formulas (31) to (34) when the reflection spectrum is measured with a colorant particle dispersion using the colorant. In order to adjust the reflection spectrum to satisfy the following Formulas (31) to (34) with mixing the colorant dispersion, an ordinary skilled person will not need to perform specific trial and error.

2≦A₄₁₅+A₄₆₀≦24 Formula (31)

wherein A₄₁₅ and A₄₅₀ represent reflectance (in terms of %) at a wavelength of 415 nm and reflectance (in terms of %) at a wavelength of 460 nm, respectively,

20≦A₅₁₀−A₄₉₀≦40 Formula (32)

wherein A₅₁₀ and A₄₉₀ represent reflectance (in terms of %) at a wavelength of 510 nm and reflectance (in terms of %) at a wavelength of 490 nm, respectively,

2≦A₅₅₀−A₅₃₀≦16 Formula (33)

70≦A₅₅₀ Formula (14)

wherein A₅₅₀ and A₅₃₀ represent reflectance (in terms of %) at a wavelength of 550 nm and reflectance (in terms of %) at a wavelength of 530 nm, respectively;

Examples of a colorant preferably used for the yellow toner of the present invention are yellow colorant belonging to Group X or Group Y.

[Group X]: C.I. Pigment Yellow 3, C.I. Pigment Yellow 35, C.I. Pigment Yellow 65, C.I. Pigment Yellow 74, C.I. Pigment Yellow 98 and C.I. Pigment Yellow 111.

[Group Y]: C.I. Pigment Yellow 9, C.I. Pigment Yellow 36, C.I. Pigment Yellow 83, C.I. Pigment Yellow 110, C.I. Pigment Yellow 139, C.I. Pigment Yellow 181 and C.I. Pigment Yellow 153.

A yellow toner containing a mixture of a yellow colorant selected from Group X and the other yellow colorant selected from the Group Y having a weight ratio between 65:35 and 95:5 is specifically preferred.

The yellow colorant of Group X can be selected from commercially available colorants having a grade of from “very greenish yellow” to “greenish yellow”. The yellow colorant of Group Y can be selected from commercially available colorants having a grade of from “(normal) yellow” to “reddish yellow”.

The total content of the yellow colorant of Group X and the yellow colorant of Group Y in the yellow toner particles is in the range of from 2 to 12 parts by weight, and preferably from 4 to 10 parts by weight with respect to 100 parts by weight of the yellow toner particles.

The toner compositions of the aforesaid cyan toner, magenta toner and yellow toner used for producing a color print of the present invention will be described.

The toner of the present invention preferably has a volume-based median particle diameter (D50ᵥ) of 3.0-8.0 μm.

By controlling the volume-based median particle diameter within the above-described range, it is possible to faithfully reproduce an image made of very fine dots such as, for example, 1200 dpi (dpi: dots number per inch (2.54 cm)).

By controlling the volume-based median particle diameter of the toner used in the present invention within the above-described range, it is possible to achieve a very fine toner image required for producing a photographic image or a thin line image. Thus, by faithfully reproducing an image made of very fine dots produced in digital image formation, it is possible to produce a high precision image equal to or better than a printed image made by a printing press. Therefor, it can be produced a high image quality full-color print comparable with a printed image made by a printing press without making an effort to make a plate for a printing press.

The color change can be restrained regardless of the adhesion amount of the toner and excellent color reproduction can be achieved by making the particle diameter of color toner particles within the above-described range. When, the particle size of the toner is smaller than 3.0 μm of a volume-based median particle diameter, light scattering will be increased. This will result in color shift between a halftone image produced with a small adhesion amount of toner and a solid image produced with a large adhesion amount of toner. More specifically, there may be a case in which a halftone image becomes bluish color.

The toner particle size can be controlled by the density and amount of the aggregating agent, aggregating time and the composition of the polymer itself when the color toner particle is formed with a polymerization method.

The volume-based median particle diameter (D50ᵥ) of toner can be determined and calculated employing a measuring device in which a data processing computer system is connected to “COULTER MULTISIZER III” (produced by Beckman Coulter Inc.).

The measuring method is specifically as follow: after 0.02 g of toner is added into 20 ml of an aqueous surfactant solution (a surfactant solution in which a neutral detergent containing a surfactant component is diluted with pure water by a factor of 10 in order to disperse the toner), and fitted therein, ultrasonic dispersion is carried out for one minute to prepare a toner dispersion. This toner dispersion is injected in a beaker on a sample stand, into which “ISOTON II” (produced by Beckman Coulter Inc.) is introduced, employing a pipette until displayed concentration of the measuring device reaches 5 to 10%. As to the measuring device, the number of measured particle accounts and an aperture diameter are set to 25,000 and 50 μm, respectively, and the particle diameter at 50% from the larger value of the volume integral distribution is designated as a volume-based median particle diameter.

The toner particles in the toner of the present invention preferably have a coefficient of variation (CV value) of a volume based particle diameter distribution in the range of 2% to 21%, and more preferably from 5% to 15%.

A coefficient of variation (CV value) of a volume based particle diameter distribution is a value obtained from (A) standard deviation in the volume based particle distribution by dividing (B) median diameter (D50ᵥ) in the volume based particle distribution (A/B). This value can be obtained from the following Scheme (1).

CV value (%) of a volume based particle diameter distribution=((standard deviation in the volume based particle distribution)/(median diameter (D50ᵥ) in the volume based particle distribution))×100. Scheme (1)

When the CV value is small, it means that the particle diameter distribution is narrow, hence, the size of the toner particles is uniform. When it is small, a toner having toner particles of a uniform size can be obtained. This toner makes it possible to reproduce an image containing fine dots and thin lines which are required for a digital image formation. In making a print of a photographic image, this toner having toner particles of a uniform size can produce an image of high quality which is equivalent to or better than the image made with a process ink.

The toner of the present invention contains preferably toner particles having an average circularity of 0.930 to 1.000 defined by the following Scheme (2), and more preferably, of 0.950 to 0.995 from the viewpoint of increasing transferring efficiency.

Average circularity=(circumferential length of a circle having the same projective area as that of a particle image)/(circumferential length of the projective particle image) Scheme (2)

The toner particles in the toner of the present invention have preferably a softening point (Tₛₚ) of from 70 to 110° C., and more preferably from 70 to 100° C.

The colorant used in the toner is required to be stable and not to change its light absorption spectrum even by being subjected to heat. By setting the softening point to be within the above-described range, the thermal effect which may be given by the heat applied during fixing can be decreased. As a consequence, an image can be formed without imposing undue thermal stress to the components of the aforementioned colorant. As a result, an image having a wide and stable color reproduction property can be reliably produced.

By adjusting each softening point of yellow toner, magenta toner and cyan toner within the above-described range, an appropriate melt state of each of yellow toner, magenta toner and cyan toner can be obtained in a fixing process, whereby excellent color reproduction for the secondary color can be produced.

“Appropriate melt state of each of yellow toner, magenta toner and cyan toner” described herein is referred to a state in which when a color image is produced by superimposing another color toner image on each toner image produced with yellow toner, magenta toner and cyan toner, each colorant of yellow, magenta and cyan contained in the each toner image produced by each of the aforesaid yellow toner, magenta toner and cyan toner and the colorant contained in another color toner will be uniformly dispersed and are developed to form a color. For example, when a yellow toner image and a magenta toner image are superimposed on a recording material, the interface of the binder resin in each color image is disappeared in spite of the superimposing and fixing two different color images, and a yellow colorant and a magenta dye are both evenly dispersed to produce a color. In this case, the yellow colorant and the magenta colorant are not bled out up to the region outside the formed color image region.

By adjusting the softening point of the toner within the above-described range, it can be possible to fix the image at a lower temperature than the conventional fixing temperature. As a result, electric power consumption will be decreased and image formation fitting to the environment can be realized.

The softening point of a toner can be controlled by the following methods, singly or in combination:

(1) the kind or the composition of monomer used for resin formation is adjusted;
(2) the molecular weight of a resin is controlled by the kind or the amount of a chain-transfer agent; and
(3) the kind or amount of a wax is controlled.

Herein, the softening point temperature of a toner is measured as described below. First, after placing 1.1 g of a color toner in a Petri dish to be flattened out, and standing for at least 12 hours at 20° C. and 50% RH, a pressure of 3,820 kg/cm² is applied for 30 seconds employing a molding machine “SSP-10A” (produced by Shimadzu Corporation) to prepare a 1 cm diameter cylindrical molding sample.

Next, the resulting sample is extruded from a cylindrical die hole (1 mm in diameter×1 mm) employing a 1 cm diameter piston after termination of pre-heating under the conditions of an applied load of 196 N (20 kgf), a starting temperature of 60° C., and a temperature raising rate of 6° C./minute, by using a flow tester “CFT-500D” (produced by Shimadzu Corp.) at 24° C. and 50% RH, and offset method temperature T_{offset} measured on the basis of melting temperature determination of the temperature raising method with setting at an offset value of 5 mm is designated as a softening point temperature of the color toner.

The producing method of a toner used in the present invention will be described.

The toner used in the present invention is composed of at least particles containing a resin and a colorant (hereafter, these particles are referred to colored particles). The producing method of the colored particles composing the toner of the present invention is not particularly limited and they can be produced with conventionally known methods. They can be produced with a pulverization method containing the steps of kneading, pulverization, and classification. They can also be produced with a polymerization method (for example, emulsion polymerization method, a suspension polymerization method, and a polyester molecule elongation method) in which a polymerizable monomer is polymerized, at the same time, particle formation is done by controlling the shape and dimension of the particles.

Among these methods, the production of the toner with a polymerization method is most preferable because the required toner can be formed with controlling the shape and dimension of the particles during the production method and it enables to produce small sized toner particles which can faithfully reproduce an image of fine dots. Among known polymerization methods, an emulsion aggregation method is one of the efficient methods for producing colored particles used for the mother particles before adding an external additive. In this method, resin particles having a size of about 120 nm are prepared with an emulsion polymerization method or a suspension polymerization method, and then, the obtained resin particles are aggregated to form the color particles used for the mother particles before adding an external additive. Further, it is preferable that the colored particles have a core-shell structure. This structure is preferably made as follows. The core is produced with a resin containing a colorant by the aforesaid aggregation, and then a resin is covered on a surface of the core as a shell resulting to form a core-shell structure.

In the following, it is disclosed an example of a method for producing a toner having a core-shell structure made with an emulsion aggregation method. An emulsion aggregation method contains the following steps for producing a toner.

(1) a step of preparing a resin particle dispersion used for forming a core
(2) a step of preparing a colorant particle dispersion
(3) a step of aggregation-fusion of resin particles used for a core.
(4) a first ripening step
(5) a shell forming step
(6) a second ripening step
(7) a cooling step
(8) a washing step
(9) a drying step
(10) a step of treating external additive

### (1) A Step of Preparing a Resin Particle Dispersion Used for Forming a Core

In this step, a polymerizable monomer for forming resin particles for a core is added in a water based solvent and polymerization is carried out so as to produce resin particles having a size of about 120 nm. For example, resin particles containing a wax can be formed by polymerization of a polymerizable monomer dissolved a wax under a dispersed condition in a water based solvent.

### (2) A Step of Preparing a Colorant Particle Dispersion

In this step, a colorant is dispersed in a water based solvent, and colorant particles having a size of about 110 nm are prepared.

### (3) A Step of Aggregation-Fusion of Resin Particles Used for a Core.

In this step, the above-described resin particles and colorant particles are aggregated and, at the same time, these particles are allowed to fuse to produce core particles. In this step, an alkali metal salt or an alkali earth metal salt is added as an aggregation agent into a water based solvent mixed with the resin particles and the colorant particles. Then, the mixture is heated at a temperature above the glass transition temperature of the resin and below the melt peak temperature of the mixture in order to promote the aggregation and fusion of the resin particles.

More specifically, the resin particles and the colored particles, prepared as described above, are added to a reaction system and an aggregation agent such as magnesium chloride is added. Formation of particles are done by aggregating and simultaneously fusing the resin particles and the colored particles. At the moment when the particle size reaches at a target size, a salt such as sodium chloride is added to stop the aggregation.

### (4) A First Ripening Step

In this step, after the above-described aggregation-fusion step, ripening of the resin particles is carried out by heating until the shape of the resin particles for a core becomes a required shape.

### (5) A Shell Forming Step

In this step, shell forming particles are added in a dispersion of a core prepared in the first ripening step so as to form a shell on a surface of a core.

### (6) A Second Ripening Step

In this step, after the above-described shell forming step, the shell coating on the surface of a core is made strong and, at the same time, ripening of the colored particles is carried out until the shape of the colored particles becomes a required shape by applying heat to the reaction system.

### (7) A Cooling Step

This step is a cooling treatment process (a rapid cooling treatment) of a dispersion of the above colored particles. The cooling rate as a condition of the rapid cooling treatment is in the range of 1-20° C./min. Examples of cooling treatment methods may include, but not limited to, a cooling method by externally charging a refrigerant into a reaction vessel or a cooling method of introducing cold water directly into the reaction system.

### (8) A Washing Step

This step is composed of solid-liquid separation of colored particles from the colored particle dispersion which was cooled down to the prescribed temperature in the above step and washing so that adhered components such as surfactants or coagulants are removed from the colored particles which were subjected to the solid-liquid separation treatment resulting into a coagulated cake, a so-called wet toner cake.

The washing treatment is carried out with water until the filtrate reaches a specific electric conductivity, for example, about 10 μS/cm. Filtration methods include, but are not limited to, a centrifuge separation method, a filtration method under reduced pressure employing a Nutsche filter, or a filtration method employing a filter press.

### (9) A Drying Step

This step is to prepare dried colored particles by drying treatment of the colored particles which were subjected to the above washing treatment. Driers employed in this step include a spray drier, a vacuum freeze drier, or a reduced-pressure drier. However a standing rack drier, a moving rack drier, a fluidized-bed drier, a rotary drier, or a stirring drier are preferred.

The moisture content of the dried colored particles is preferably at most 5 weight %, and more preferably at most 2 weight %. If dried colored particles are coagulated due to weak attraction force, the coagulate may be subjected to a disintegration treatment, via a mechanical disintegrating apparatus such as a jet-mill, a Henschel mixer, a coffee mill, and a food processor.

### (10) A Step of Treating External Additive

This step is a toner producing step by mixing an external additive to dried toner particles when necessary.

By conducting the above-described steps, a toner having a core-shell structure can be produced with an emulsion aggregation method.

Next, specific examples of a resin, a colorant or a wax constituting the toner of the present invention will be detailed.

### [Binder Resin]

The following well-known resins can be cited as a binder resin which constitutes the toner used for the present invention: a vinyl resin (for example, a styrene resin, a (metha)acrylic resin, a styrene-(metha)acrylics copolymer resin, an olefin resin), a polyester resin, a polyimide resin, a polycarbonate resin, a polyether resin, a polyvinylacetate resin, a polysulfone resin, an epoxy resin, a polyurethane resin and a urea resin.

When a polyester resin is used, a resin which is made by condensation of a well known alcohol having 2 or more hydroxyl groups and a well known carboxylic acid having 2 or more carboxyl groups.

Examples of an alcoholic component having 2 or mare hydroxyl groups include: an aliphatic dial such as neo pentylglycol and 1,4-butenediol; and an aromaticdiol such as an alkylene oxide adduct of bisphenol. These alcohols may be used in combination of two or more sorts of alcohols.

Examples of a carboxylic acid component having 2 or more carboxyl groups preferably used include: fumaric acid, maleic acid, itaconic acid, and terephthalic acid. It may be add a carboxylic acid component having 3 carboxylic groups such as benzene tricarboxylic acid in an amount of about 5 to 20 weight % to the resin.

Resins usable in a toner of the present invention are not particularly limited. Most representative examples are polymers formed via polymerization of polymerizable monomers called vinyl monomers which are described below. A polymer constituting a resin usable in the present invention, which is composed of a polymer obtained via polymerization of at least one type of polymerizable monomer, may be prepared by employing the vinyl monomers solely or in combination with plural monomers.

Specific examples of a polymerizable vinyl monomer are shown below:

(1) styrene or styrene derivatives:
styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene;
   (2) methacrylic acid ester derivatives:
methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate;
   (3) acrylic acid ester derivatives:
methyl acrylate, ethyl acrylate, iso-propyl acrylate, n-butyl v, t-butyl acrylate, iso-butyl acrylate, n-octyl acrylate, 2-ethylhexyl acrylate, stearyl acrylate, lauryl acrylate and phenyl acrylate;
   (4) olefins;
ethylene, propylene and isobutylene;
   (5) vinyl esters:
vinyl propionate, vinyl acetate and vinyl benzoate;
   (6) vinyl ethers:
vinyl methyl ether and vinyl ethyl ether;
   (7) vinyl ketones:
vinyl methyl ketone, vinyl ethyl ketone and vinyl hexyl ketone;
   (8) N-vinyl compounds:
N-vinyl carbazole, N-vinyl indole and N-vinyl pyrrolidone;
   (9) others:
vinyl compounds such as vinylnaphthalene and vinylpyridine; acrylic acid or methacrylic acid derivatives such as acrylonitrile, methacrylonitrile and acrylamide.

There may also usable polymerizable monomers containing ionic-dissociative group, as a vinyl monomer, and including, for example, those having a side chain containing a functional group such as a carboxyl group, a sulfonic acid group or a phosphoric acid group as described below. The colorant of the present invention has a weak alkaline property as mentioned above, as a result, combining with the aforementioned monomer is preferable because it will improve the degree of dispersion of the colorant in the resin.

Specific examples of an acid containing monomer are: a carboxyl group containing monomer such as acrylic acid, methacrylic acid, maleic acid, itaconic acid, cinnamic acid, fumaric acid, monoalkyl maleate, monoalkyl itaconate; a sulfonic acid group containing monomer such as styrenesulfonic acid, allylsulfosuccinic acid, 2-acrylamido-2-methylpropanesulfonic acid; and a phosphoric acid group containing monomer such as acid phosphooxyethyl methacrylate.

Further, a cross-linked resin can be obtained using poly-functional vinyl compounds. Examples of such poly functional vinyl compounds are shown below.

Examples of a poly-functional vinyl compound include: divinylbenzene, ethylene glycol dimethacrylate, ethylene glycol diacrylate, triethylene glycol dimethacrylate, triethylene glycol diacrylate, neopentylglycol dimethacrylate and neopentylglycol diacrylate.

The toner of the present invention may contain a wax. Examples of a wax which can be used are conventionally known compounds shown below:

(1) polyolefin wax such as polyethylene wax and polypropylene wax;
(2) long chain hydrocarbon wax such as paraffin wax and sasol wax and microcrystalline wax;
(3) dialkyl ketone type wax such as distearyl ketone;
(4) ester type wax such as carnauba wax, montan wax, trimethylolpropane tribehenate, pentaerythritol tetramyristate, pentaerythritol tetrabehenate, pentaerythritol diacetate dibehenate, behenyl behanate, glycerin tribehenate, 1,18-octadecanediol distearate, trimellitic acid tristearate, and distearyl meleate; and
(5) amide type wax such as ethylenediamine dibehenylamide and trimellitic acid tristearylamide.

The melting point of a wax usable in the present invention is preferably 40 to 125° C., more preferably 50 to 120° C., and still more preferably 70 to 90° C. By using a wax having a melting point falling within the foregoing range, heat stability of the toners can be ensured. And stable toner image formation can be achieved without causing cold offsetting even when the image is fixed at a relatively low temperature. The wax content of the toner is preferably in the range of 1 weight % to 30 weight %, and more preferably 5 weight % to 20 weight %.

In the production process of the yellow toner, the magenta toner and the cyan toner of the present invention, it can be added an external additive of inorganic particles or organic particles having a number average primary particle size of 4 to 800 nm to prepare the targeted toner.

By incorporating an external additive, fluid characteristics and charging property of the toner can be improved. In addition, improved cleaning property of the toner is also achieved. The external additive is not specifically limited, and includes various inorganic particles, organic particles and lubricant as are shown below.

As inorganic particles, conventionally known compounds may be used. Preferable examples of inorganic particles employed are fine particles of: silica, titania, alumina and strontium titanate. These inorganic particles after subjected to hydrophobic treatment can also be used if required.

Specific example of silica fine particles includes commercially available products of: R-805 R-976, R-974, R-972, R-812 and R-809 (made by Nippon Aerosil Co., Ltd.); HVK-2150 and H-200 (made by Hoechst Corporation); and TS-720 TS-530, TS-610, H-5, MS-5 (made by Cabot Corporation.)

Example of titania particles includes commercially available products of: T-805 and T-604 (made by Nippon Aerosil Co., Ltd.); MT-100S, MT-100B, MT-500BS, MT-600, MT-600SS and JA-1, made by Teika Corporation); TA-300SI, TA-500, TAF-130, TAF-510 and TAF-510T (made by Fuji Titanium Industry Co. Ltd.); and IT-S, IT-OA, IT-OB, IT-OC (made by Idemitsu Kosan Co. Ltd.)

Example of alumina particles includes commercially available products of: RFY-C and C-604 (made by Nippon Aerosil Co., Ltd.); and TTO-55 made by (Ishihara Sangyo Co. Ltd.).

Organic particles having a number average primary particle of 10 to 2,000 nm can be used as an external additive. Examples of the organic fine particles are: homopolymer or copolymer of a styrene resin, and a methylmethacrylate resin.

A lubricant can be further added in order to improve cleaning property and transferring property of the toner. Example of the lubricant mentioned above includes: metallic salt of higher fatty acid such as stearic acid salt of zinc, aluminum, copper and magnesium; oleic acid salt of calcium, zinc, manganese, iron, copper and magnesium; palmitic acid salt of zinc, copper, magnesium and calcium; linoleic acid salt of zinc and calcium; and ricinoleic acid salt of zinc and calcium.

The external additives are preferably contained in an amount of 0.1 to 10.0 weight % based on the total weight of the toner. The external additive and the lubricant can be added with a conventionally known mixer such as a turbular mixer, Henschel mixer, Nauter mixer or a V-shape mixer.

The two-component developer which is preferably used in the method of the present invention for producing a color print will be described. The developer which is preferably used in the method of the present invention is a two-component developer produced by mixing the aforesaid cyan toner or magenta toner with a carrier.

Examples of a carrier usable in the two-component developer used for the present invention are: magnetic particles composed of commonly known materials such as metal like iron, ferrite or magnetite, or alloys of the foregoing metals and metal like aluminum or lead. Of these, ferrite particles are specifically preferable. Further, a coat carrier obtained by coating the magnetic particle surface with a coating agent and a binder type carrier formed by dispersing magnetic powder in a binder resin are also usable as the carrier.

The coating resin constituting the coat carrier is not specifically limited, and examples thereof include a polyolefin based resin, a polystyrene based resin, a styrene-acryl based copolymer resin, silicone based resin, a polyester resin, a fluorine-containing resin and so forth. The binder resin constituting the binder type carrier are not specifically limited, and commonly known resins are usable, such as a styrene-acryl based copolymer resin, a polyester resin, a fluorine resin, phenol resin and so forth.

The carrier preferably has a volume-based particle median particle diameter of 20-100 μm, and more preferably 20-60 μm in order to obtain high quality image and to inhibit carrier fog. By using the carrier having the above-described volume-based particle median particle diameter, uniformly stood magnetic brushes are formed on developing sleeve 41, thereby a uniform image can be produced when a solid image is formed. Further, a suitable fluidity is given to the developer and a stable charge rising property can be realized. In addition, since the magnetic brushes formed on developing sleeve 41 have an appropriate height, non-uniform sweep of the toner will not occur and a good image can be stably produced.

The volume-based median particle diameter of the carrier can be determined employing a laser diffraction type particle size distribution measurement apparatus equipped with a wet disperser, HELOS (manufactured by SYMPATEC Corp.). When this method is used to measure the volume-based median particle diameter of the carrier, the following pre-treatment is performed. At first, in a beaker are added a developer, a small amount of a neutral detergent and pure water, and then fit them well with each other. Then, the clear fluid is eliminated by allowing to contact a magnet under the bottom of the beaker. Further, pure water is added and again the clear fluid is eliminated. By this procedure, the toner and the neutral detergent are eliminated and only the carrier can be isolated. The isolated carrier is dried at 40° C. to obtain a simple carrier.

Preferable carriers are, for example, coated carriers employing as coating resins, silicone based resins, copolymer resins (graft resins) of organopolysiloxane with vinyl based monomers, or polyester resins. In view of durability, stability against environment, and spent resistance, preferably listed are carriers which are covered by the resins which are prepared by allowing copolymer resins (or graft resins) of organopolysiloxane with vinyl based monomers to react with isocyanate. The vinyl based monomer to form the above-described coat carrier is a monomer having a substituent such as a hydroxyl group or the like exhibiting reactivity with isocyanate.

The two-component developer used in the present invention can be prepared by mixing the aforesaid toner and carrier. The mixing ratio of the toner to the carrier is preferably adjusted to have a toner content of 3 to 12 weight % for the developer in the developing device, and more preferably from 5 to 9 weight %. While, with respect to the developer for replenishing, a toner content of 60 to 98 weight % is preferable for improving the image stability, and more preferably, it is 80 to 96 weight %.

As a mixer to mix the toner and the carrier, conventionally known mixers can be used. Examples of such mixer are: Henschel mixer, Nauter mixer, a V-shape mixer and a turbular mixer. Among them, Henschel mixer is most preferable.

A coat carrier preferably used in the present invention can be produced by forming a resin coat layer on a surface of a magnetic particle using conventionally known methods.

A resin coat layer can be formed on a surface of a magnetic particle using conventionally known methods such as a dry method or a wet method (a solvent coating method, a solvent immersion method). Among them, a dry method is preferable from the viewpoints of production cost and environmental load. Here, a dry method refers to a method in which thermoplastic resin particles (binder resin) and magnetic particles are mixed with heating without using a liquid such as a solvent so as to form a resin coat layer on a surface of a magnetic particle resulting in producing a coat carrier.

A wet method is a method in which a coat carrier is produced by forming a resin coat layer on a surface of a magnetic particle using a solvent. By a solvent coating method, which is one of the wet methods, a coat carrier is produced by applying a coating solution made by dissolving a binder resin in a solvent on a surface of a magnetic particle to form a resin coat layer.

Next, a non-contact developing method used in a method for producing a color print of the present invention will be described. In the method for producing a color print of the present invention, a printed matter is produced with an image forming apparatus which contains a developing device having a structure in which a toner holding member and an electrostatic latent image holding member are located in a non-contact position with each other. As described above, in the method for producing a color print of the present invention, the developer used in a non-contact developing method is preferably a two-component developer formed by mixing a toner and a carrier.

The image forming method comprising the step of flying only the toner particles by opposing the photoreceptor and the developing device located in a non-contact position with each other has been applied to an image forming method called as a multiple image forming method in which an image is produced by superimposing a plurality of color toners. However, since the photoreceptor and the developing device are located in a non-contact position, the developing efficiency tends to be lower compared with a contact development. In addition, selective development caused by charging property will easily occur after repeated image formation. As a result, there is a problem that variation of an amount of the developed toner will be large and deterioration of the image such as color shift of the second color tends to be high.

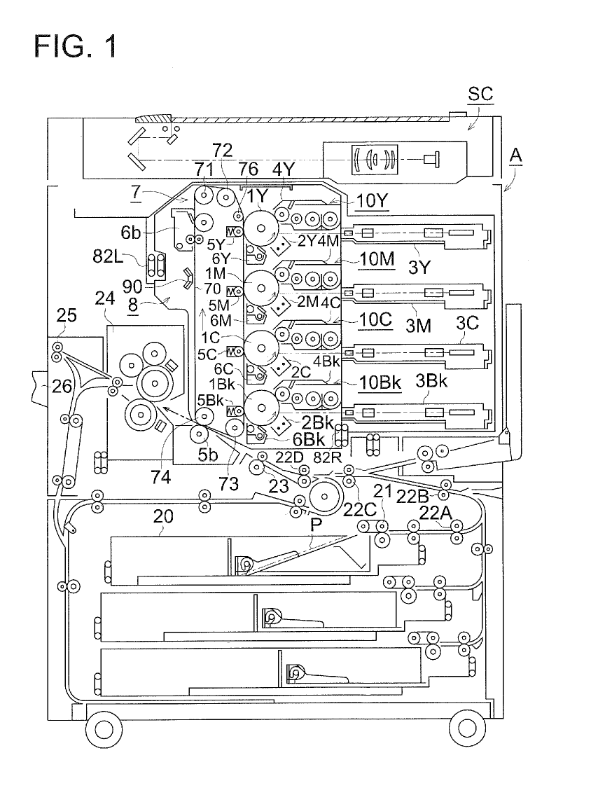

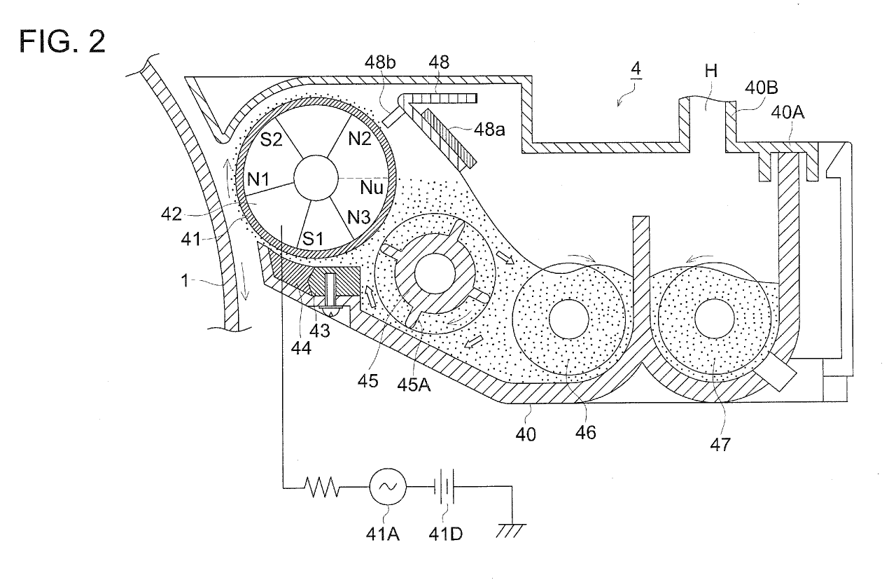

FIG. 2 is a cross sectional view of a representative developing device which can supply a toner to a surface of an electrostatic latent image holding member (a photoreceptor drum) with a non-contact developing method. Here, the developing device which can be used in the method of a color print of the present invention is not limited to the developing device having a structure shown in FIG. 2. The method of a color print of the present invention can be used, for example, in a full-color electrophotographic image forming apparatus as shown in FIG. 1 which will be described later by providing each of the non-contact developing devices 4 with a yellow toner, a magenta toner, a cyan toner and a black toner respectively.

Developing device 4(4Y-4Bk) for each color each respectively contain a two-component developer of yellow (Y), magenta (M), cyan (C) and black (Bk) color. They are arranged in a position around photoreceptor drum 1 (1Y-1Bk) (an electrostatic latent image holding member) with a predetermined distance.

In developing device 4, a toner is supplied to photoreceptor drum 1 through developing sleeve 41 which corresponds to “a toner holding member” of the present invention. Developing sleeve 41 is arranged to have a predetermined gap with respect to photoreceptor drum 1.

The gap formed between developing sleeve 41 and photoreceptor drum 1 is called as a developing gap. This gap is preferably 0.05 to 0.5 mm, and more preferably 0.1 to 0.4 mm. In addition, developing sleeve 41 rotates in an inverse direction with respect to the rotation direction of photoreceptor drum 1 as is shown in FIG. 2.

Thus, developing device 4 of FIG. 2 is arranged in a non-contact position with developing sleeve 41. Thin layer formation of a toner is done on developing sleeve 41. The thin layered toner is supplied on photoreceptor drum 1 by flying and develops an electrostatic latent image formed on photoreceptor drum 1.

Developing device 4 shown in FIG. 2 is composed of the followings: housing 40 incorporating a two-component developer made of a toner and a carrier; magnetic roller 42 having a fixed magnetic pole; developing sleeve 41 arranged magnetic roller 42 inside of the sleeve; layer thickness regulating member 43 which makes the developer layer formed on developing sleeve 41 to be a predetermined thickness; developer receiving member 44; developer removing plate 48; conveying and feeding roller 45; and a pair of stirring screws 46 and 47.

Developing sleeve 41 is a cylindrical member having an outer diameter of 10-50 mm and the surface of which is composed of aluminum, stainless steel or conductive resin. For example, it may be used a cylindrical member formed a coating layer of a conductive resin on an outer surface of a metallic cored bar. Since the surface of developing sleeve 41 is a place where thin layer formation of a toner is done, as described above, it is preferable that developing sleeve 41 has a certain surface roughness. The surface roughness values of developing sleeve 41 should be: Ra of 0.2 to 2.5 μm, preferably 0.5 to 1.5 μm; and Rsm of 10 to 300 μm, preferably 30 to 150 μm. Here, Ra indicates an average center line roughness and Rsm indicates an average distance of a surface roughness. Both of them can be measured and calculated using a known measuring apparatus and a measuring procedure.

Magnetic roller 42 is incorporated inside of developing sleeve 41 and is fixed with the same axis as used for fixing developing sleeve 41. A plurality of magnet poles N1, N2, N3, S1 and S2 are alternatively arranged to produce a magnetic force onto the nonmagnetic outer peripheral surface of developing sleeve.

Layer thickness regulating member 43 is arranged opposing to pole N3 of magnetic roller 42 and it is arranged to have a predetermined distance to developing sleeve 41. By arranging as this position, it can be possible to uniformly form a thin toner layer on a surface of developing sleeve 41, and at the same time, triboelectric charge is given to the thin toner layer. Layer thickness regulating member 43 is, for example, made of magnetic stainless steel or urethane rubber having a rod shape or a plate shape. Layer thickness regulating member 43 is pressed onto the surface of developing sleeve 41 and regulates the layer thickness of a two-component developer on a peripheral surface of developing sleeve 41.

Layer thickness regulating member 43 is preferably in a pressure contact with developing sleeve 41 at a pressure of 0.1 to 5.0 N/cm. By pressing to developing sleeve 41 at a pressure in the above-described range, it can be achieved even and uniform toner transfer on developing sleeve 41. It can be avoided appearance of an image defect such as a white line.

Developer receiving member 44 is arranged at a position of a downstream side of the rotation direction of developing sleeve 41 so as to have a predetermined distance. Developer receiving member 44 stably holds the developer layer which has been regulated with layer thickness regulating member 43 on developing sleeve 41 without falling down of the developer layer. Developer receiving member 44 is made of a nonmagnetic material such as an ABS resin, and it is arranged in a position adjacent to the edge of layer thickness regulating member 43. Therefore, it is possible that developer receiving member 44 is integrated with layer thickness regulating member 43.

Developer removing plate 48 is arranged opposing to pole N2 of magnetic roller 42. Developer removing plate 48 removes the developer from developing sleeve 41 by the effect induced by a repulsive magnetic filed caused by pole N2 and N3 and magnet plate 48a which is provided in the rear side of Developer removing plate 48.

Conveying and feeding roller 45 conveys the removed developer by developer removing plate 48 to stirring screw 46, and at the same time, feeds the developer stirred by stirring screw 46 to layer thickness regulating member 43. It will stably feed the toner to developing sleeve 41. A water wheel shaped roll provided with wheel member 45A as shown in FIG. 2 or a roll of a sponge is used for conveying and feeding roller 45. Conveying and feeding roller 45 preferably has a diameter in the range of 0.2 to 1.5 times of a diameter of developing sleeve 41. By setting the diameter of conveying and feeding roller 45 in the above-described range with respect to developing sleeve 41, supply of the toner can be performed in the proper quantity and appearance of an image defect such as a stripe can be avoided.

Stirring screws 46 and 47 each rotate in an opposed direction with the same speed to stir and mix the toner and the carrier contained in developing device 4 so as to uniformly disperse them.

Developing device 4 of FIG. 2 is provided with: a direct current power source which impresses direct current bias voltage V_{DC1} to developing sleeve 41; an alternating current power source which impresses alternating current bias voltage V_{AC} to developing sleeve 41; and direct current power sources which impress direct current bias voltages V_{DC2} and V_{DC3} to conveying and feeding roller 45 and layer thickness regulating member 43 respectively. Thus, by impressing voltages to developing sleeve 41 and other aforesaid members with direct current power sources and alternating current power sources, a uniform thin toner layer having a thickness of 10 to 100 μm can be formed on developing sleeve 41. The toner can be supplied from the surface of developing sleeve 41 to photoreceptor drum 1.

Namely, in developing device 4 of FIG. 2, the developer is stirred with stirring screws 46 and 47 and the developer is supplied to developing sleeve 41 with conveying and feeding roller 45. At this moment, the supplied toner is subjected to triboelectric charging and the layer thickness of the toner is regulated with layer thickness regulating member 43 to result in forming a thin toner layer having a uniform thickness of 10 to 100 μm on developing sleeve 41. Then, in the developing gap, both direct current bias voltage V_{DC1} and alternating bias voltage V_{AC} are added and they are impressed. The toner in the thin toner layer formed on developing sleeve 41 flies toward photoreceptor drum 1 to develop a latent image formed on the surface of the photoreceptor.

Each bias voltage has preferably the following value as an example. Direct current bias voltage V_{DC2} which is impressed to developing sleeve 41 with a direct current power source is preferably set to be 200 to 900 V. It is preferable that the voltage difference between direct current bias voltage V_{DC1} and direct current bias voltage V_{DC2} which is impressed to conveying and feeding roller 45 is set to be 100 to 200 V. It is preferable that the voltage difference between direct current bias voltage V_{DC1} and direct current bias voltage V_{DC3} which is impressed to layer thickness regulating member 43 is set to be 50 to 150 V. Further, alternating current bias voltage V_{AC} which is impressed to developing sleeve 41 with an alternating current power source is preferably set to have an inter-peak voltage of 1.6 kV and a frequency of 2.0 kHz.

The developer which has developed the latent image formed on photoreceptor drum 1 is removed by the effect induced by a repulsive magnetic filed caused by pole N2 and N3 and magnet plate 48a which is provided in the rear side of Developer removing plate 48. Then the removed developer is transferred again to stirring screw 46 with conveying and feeding roller 45.

A fresh toner is replenished from a replenishing toner container (not shown in the figure) to developing device 4 of FIG. 2. The replenishment of the toner is carried out when the density of the toner in housing 40 is detected to be lower than the predetermined value by using with density detection sensor 49. The replenishment of the toner to developing device 4 is done, for example, with a hopper which constitutes (not shown in the figure) a replenishing toner container through toner replenishing inlet H located in top plate 40A (which will be described later) via a toner conveying path (not shown in the figure).

Top plate 40A is provided with replenishing inlet H of a developer conveying path for conveying the toner at a surface of an edge position of an upstream of stirring screw 47. By arranging the members in this way, the newly replenished toner will be sufficiently stirred with stirring screws 46 and 47 and replenished toner can be charged and can be conveyed and supplied to developing sleeve 41.

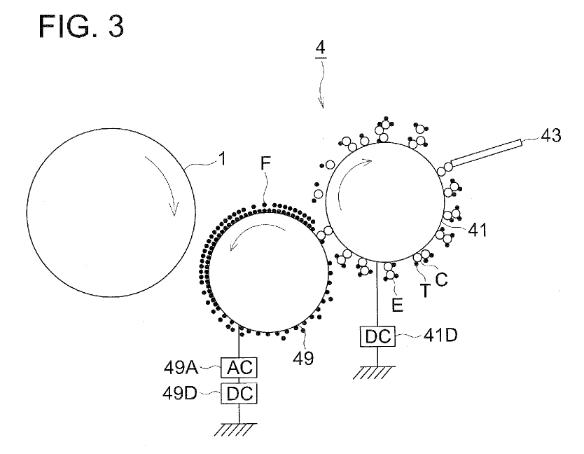

There is known “a hybrid developing method” which uses a two-component developer as one of non-contact developing methods. The developing device using this developing method arranges a toner conveying roller called as a donor roller between a magnetic roller holding the above-described two-component developer and a photoreceptor drum. The toner is supplied to the surface of the photoreceptor drum through the donor roller. Namely, a uniform thin toner layer is formed on a donor roller by using a two-component brush developing mechanism. Then, the toner is made fly from the donor roller to the photoreceptor drum so as to develop the electrostatic latent image formed on the photoreceptor drum. FIG. 3 is a cross-sectional structural view of developing device 4 using a hybrid developing method.

Developing device 4 contains: magnetic roller 41 which forms and holds magnetic brushes E composed of toner T and carrier C and rotates (magnetic roller 41 corresponds to the above-described developing sleeve); and toner conveying roller 49 which is arranged to be opposed to magnetic roller 41. Toner conveying roller 49 is the above-described donor roller. Developing device 4 of FIG. 3 is provided with magnetic roller 41 and toner conveying roller 49 in an arrangement that a charged thin toner layer is formed on a surface of toner conveying roller 49 with magnetic brushes E formed on magnetic roller 41.

Toner conveying roller 49 and magnetic roller 41 are made to rotate in the same direction in the region in which toner conveying roller 49 and magnetic roller 41 are faced to each other. Further, toner conveying roller 49 and photoreceptor drum 1 are made to rotate in the same direction in the region in which both members are faced to each other.

As shown in FIG. 3, developing device 4 is provided with: direct current power source 49D which impresses direct current bias voltage V_{DC3} to toner conveying roller 49; alternating current power source 49A which impresses alternating current bias voltage V_{AC} to toner conveying roller 49; and direct current power source 410 which impresses direct current bias voltages V_{DC1} to magnetic roller 41. Developing device 4 is also provided with brush height regulating member 43 which regulates the height of the magnetic brushes E to a predetermined height.

Toner conveying roller 49 is a cylindrical member having a surface which is composed of aluminum, SUS or a conductive resin. For example, it may be used a cylindrical member formed a coating layer of a conductive resin on an outer surface of a metallic cored bar. It may be used a cylindrical member formed a coating layer of a semiconductive resin on an outer surface of a metallic cored bar.

The gap (or called as a toner cloud forming gap) between magnetic roller 41 and toner conveying roller 49 is preferably from 0.3 to 1.5 mm, for example.

Further, the gap between magnetic roller 41 and brush height regulating roller 43 is set to bring magnetic brushes E in contact with the surface of toner conveying roller 49. Although the gap becomes different depending on the size of carrier and a toner concentration in a two-component developer, the gap is preferably set to be from 0.3 to 1.5 mm, for example, in a two-component developer containing carrier particles having a volume-based median size of 50 μm and toner having a toner concentration of 6%.

Further, the gap (or developing gap) between toner conveying roller 49 and photoreceptor drum 1 is set, for example, from 0.05 to 0.5 mm, and preferably from 0.1 to 0.4

In developing device 4 of FIG. 3, the toner and the carrier are stirred and charged with, for example, a stirring screw mixer (not shown in the figure). The charged toner is then supplied onto magnetic roller 41 to form magnetic brushes E on the surface of the magnetic roller 41. The height of magnetic brushes E is regulated by brush height regulating member 43. Then, in the toner forming gap, the toner is supplied to the surface of toner conveying roller 49 with magnetic brushes whose height is regulated. Thus the charged toner layer is formed.

In a tone cloud forming gap, an electric filed is formed by a voltage difference between direct current bias voltage V_{DC3} applied onto toner conveying roller 49 by direct current power source 49D and direct current bias voltage V_{DC1} applied onto magnetic roller 41 by direct current power source 41D. By applying this electric filed, the toner constituting the magnetic brushes is let to fly onto the surface of toner conveying roller 49, whereby a charged toner layer F made of only the toner particles is formed on the surface of toner conveying roller 49.

In the developing gap formed with toner conveying roller 49 and photoreceptor drum 1, the toner in the charged toner layer F on toner conveying roller 49 is made fly from toner conveying roller 49 to photoreceptor drum 1, whereby a latent image formed on photoreceptor drum 1 is developed. Then, in the developing gap, both direct current bias voltage V_{DC1} produced by direct current power source 49D and alternating bias voltage V_{AC} produced by alternating current power source 49A are added and they are impressed to toner conveying roller 49. By the effect of the electric filed produced by these bias voltages, the toner in the thin toner layer formed on toner conveying roller 49 flies.

The charge amount of the toner in a charged toner layer F formed on toner conveying roller 49 is preferably from 5 to 20 μC/g, and more preferably from 5 to 10 μC/g.

Here, the charge amount of the toner is a value obtained under a normal temperature and normal humidity environment (20° C./50% RH) with a suction type charge amount measuring device.

The direct current bias voltage V_{DC3} applied onto toner conveying roller 49 by direct current power source 49D is preferably, for example, from 200 to 900 V, and a voltage difference between this direct current bias voltage V_{DC3} and direct current bias voltage V_{DC1} applied onto magnetic roller 41 is preferably, for example, from 100 to 250 V. When the voltage difference between direct current bias voltage V_{DC3} and direct current bias voltage V_{DC1} are set as above, the thickness of charged toner layer F formed on toner conveying roller 49 is preferably made from 10 to 100 μm.

Further, alternative current bias voltage V_{AC} applied onto toner conveying roller 49 by alternative current power source 49A is preferably made to have, for example, an inter-peak voltage of 1.6 kV and a frequency of 2.7 kHz.

Further, developing device 4 of FIG. 3 may be provided with a toner recovering device for recovering the toner particles which are not used for developing the electrostatic toner image formed on photoreceptor drum 1 among the toner particles forming the charged toner layer on toner conveying roller 49. This specific toner recovering device may be used as a toner recovering device and also it may be used a structure in which magnetic brushes formed on magnetic roller 41 rub toner conveying roller 49 to recover the toner particles.

Then, an examples of an electrophotographic image forming apparatus enabling to perform the method for forming a color print of the present invention is described. FIG. 1 is a schematic view showing an example of a full-color image forming apparatus in which image formation of a two-component development system is feasible with a non-contact developing method.

In FIG. 1, 1Y, 1M, 1C and 1Bk each designate photoreceptors; 4Y, 4M, 4C and 4Bk each designate a developing device of a non-contact developing method; 5Y, 5M, 5C and 5Bk each designate primary transfer rollers used for a primary transfer device; 5A designates a secondary transfer roller used for a secondary transfer device; 6Y, 6M, 6C and 6Bk each designate cleaning device; the numeral 7 designates an intermediate transfer unit; the numeral 24 designates a heat roll type fixing device; and the numeral 70 designates an intermediate transfer material.

This image forming apparatus is called a tandem color image forming apparatus, which is, as a main constitution, composed of plural image forming sections 10Y, 10M, 10C and 10Bk, an intermediate transfer material unit 7 including an endless belt form of a transfer belt, paper feeding and conveying means 22A to 22D to convey recording member P and heated roll-type fixing device 24. Original image reading device SC is disposed in the upper section of image forming apparatus body A.

Image forming section 10Y to form a yellow image contains a drum-form photoreceptor 1Y; electrostatic-charging means 2Y, exposure means 3Y and developing means 4Y which are disposed around the photoreceptor 1Y; primary transfer roller 5Y; and cleaning means 6Y.

Image forming section 10M to form a magenta image as another color contains a drum-form photoreceptor 1M; electrostatic-charging means 2M, exposure means 3M and developing means 4M which are disposed around the photoreceptor 1M; primary transfer roller 5M; and cleaning means 6M.

Image forming section 10C to form a cyan image as another color contains a drum-form photoreceptor 1C; electrostatic-charging means 2Y, exposure means 3C and developing means 4C which are disposed around the photoreceptor 1C; primary transfer roller 5C; and cleaning means 6C.

Further, there are provided an image forming section 10Bk to form a black image containing a drum-form photoreceptor 1Bk; electrostatic-charging means 2Bk, exposure means 3Bk and developing means 43k which are disposed around the photoreceptor 1Bk; primary transfer roller 5Bk; and cleaning means 6Bk.

Intermediate transfer unit 7 of an endless belt form is turned by plural rollers has intermediate transfer material 70 as the second image carrier of an endless belt form, while being pivotably supported.

The individual color images formed in image forming sections 10Y, 10M, 10C and 10Bk are successively transferred onto the moving intermediate transfer material (70) of an endless belt form by primary transfer rollers 5Y, 5M, 5C and 5Bk, respectively, to form a composite color image. Recording member P of paper or the like, as a final transfer material housed in paper feed cassette 20, is fed by paper feed and conveyance means 21 and conveyed to secondary transfer roller 5A through plural intermediate rollers 22A, 22B, 22C and 22D and resist roller 23, and color images are transferred together on recording member P. The color image-transferred recording member (P) is fixed by heat roller type fixing device 24, nipped by paper discharge roller 25 and put onto paper discharge tray 26 outside a machine.

After a color image is transferred onto recording member P by secondary transfer roller 5A, intermediate transfer material 70 which separated recording member P removes any residual toner by cleaning means 6A.

The primary transfer roller 5K is always compressed to the photoreceptor 1K. Other primary rollers 5Y, 5M and 5C are each the photoreceptors 1Y, 1M and 1C, respectively, only when forming color images.

Secondary transfer roller 5A is compressed onto intermediate transfer material 70 only when recording member P passes through to perform secondary transfer.

In the process of image formation, toner images are formed on photoreceptors 1Y, 1M, 1C and 1Bk, through electrostatic-charging, exposure and development, toner images of the individual colors are superimposed on the endless belt form, intermediate transfer material 70, transferred together onto recording member P and fixed by compression and heating in heat roller type fixing device 24. The photoreceptors 1Y, 1M, 1C and 1Bk after completion of transferring a toner image to recording member P is cleaned by cleaning device 6A to eliminate the toner remained on the photoreceptors and then goes into the foregoing cycle of electrostatic-charging, exposure and development to perform the subsequent image formation.

Further, the fixing method that can be used for an image formation method using the toner of the present invention is not particularly limited, and a well-known fixing system can be applied. Examples of a well-known fixing system are: a roller fixing system containing a heat roller and a pressure roller; a fixing system containing a heat roller and a pressure belt; a fixing system containing a heat belt and a pressure roller; a belt fixing system composed of the heat belt and a press belt. Any of these systems may be used. Moreover, as a heating system, well-known heating systems can be used such as a halogen lamp system, and III fixing system.

The recording medium usable in a method for forming a full-color image of the present invention is a support which can hold a color toner image thereon. Specific examples of the recording medium are a variety of supports including: a plain paper from a thin to thick paper, a fine quality paper, an art paper, a coated paper for printing press, commercially available Japanese paper and a post card, a plastic film for OHP and a cloth. However, the recording mediums for the present invention are not limited to them.

### EXAMPLE

Next, embodiments of the present invention will now be specifically described referring to examples, but the present invention is not limited thereto. The volume-based median diameter of colorant particles was determined via “MICROTRAC URA 150” (manufactured by Honeywell Co.) under the following measurement conditions.

### [Measurement Condition]

Sample refractive index: 1.59

Sample density: 1.05 g/cm³
(converted in spherical particles)

Solvent refractive index: 1.33

Solvent viscosity: 0.797×10⁻³ Pa·S at 30° C.
1.002×10⁻³ Pa·S at 20° C.

Zero point adjustment: done by introducing ion-exchange water in a measurement cell

1. Preparation of “cyan colorant particle dispersions 1-13” and “magenta colorant particle dispersions 1-20”
(1) Preparation of “cyan colorant particle dispersion 1”

The following cyan colorants were gradually added into a solution prepared by dissolving 11.5 parts by weight of sodium n-dodecylsulfate in 160 parts by weight of ion-exchange water with stirring.

| | |
|---|---|
| Compound I-1 | 2.5 parts by weight |
| Compound II-1 | 22.5 parts by weight |

A dispersion treatment was conducted employing a homogenizer “CLEARMIX W MOTION CLM-0.8” (manufactured by M Technique Co.) to prepare “cyan colorant particle dispersion 1” having a volume-based median particle diameter of 126 nm.

(2) Preparation of “cyan colorant particle dispersions 2-13” and “magenta colorant particle dispersions 1-20”

“Cyan colorant particle dispersions 2-13” were prepared in the same manner as preparation of “cyan colorant particle dispersion 1”, except that the kind and the added amount of the cyan colorant were changed to those described in Table 2.

Further, “magenta colorant particle dispersions 1-20” were prepared in the same manner as preparation of “cyan colorant particle dispersion 1”, except that the kind and the added amount of the cyan colorant were changed to magenta colorants described in Table 3.

TABLE 2

| Cyan | | | | | |
|---|---|---|---|---|---|
| colorant | Cyan colorant | | | | |
| particle | C1 | | C2 | | Weight |
| dispersions | | Added | | Added | ratio |
| No. | Kind | amount | Kind | amount | C1:C2 |
| 1 | I-1 | 2.5 | III-1 | 22.5 | 10:90 |
| 2 | I-1 | 22.5 | III-1 | 2.5 | 90:10 |
| 3 | I-2 | 15.0 | III-1 | 10.0 | 60:40 |
| 4 | I-3 | 20.0 | III-1 | 5.0 | 80:20 |
| 5 | I-4 | 23.75 | III-1 | 1.25 | 95:5 |
| 6 | I-5 | 22.5 | III-1 | 2.5 | 90:10 |
| 7 | I-6 | 22.5 | III-1 | 2.5 | 90:10 |
| 8 | I-7 | 25.0 | — | — | — |
| 9 | I-8 | 23.5 | III-1 | 1.5 | 94:6 |
| 10 | I-9 | 19.5 | III-1 | 5.5 | 78:22 |
| 11 | I-10 | 17.0 | III-1 | 8.0 | 68:32 |
| 12 | P.B.15:3 | 25.0 | — | — | — |
| 13 | P.B.15:3 | 20.0 | III-1 | 5.0 | 80:20 |

P.B.15:3 = C.I. Pigment Blue 15:3

TABLE 3

| Magenta | | | | | |
|---|---|---|---|---|---|
| colorant | Magenta colorant | | | | |
| particle | M1 | | M2 | | Weight |
| dispersions | | Added | | Added | ratio |
| No. | Kind | amount | Kind | amount | M1:M2 |
| 1 | Complex | 22.5 | S.R.49 | 2.5 | 90:10 |
| | compound 1 | | | | |
| 2 | P.R.122 | 22.5 | P.R.9 | 2.5 | 90:10 |
| 3 | P.R.9 | 25.0 | — | — | — |
| 4 | IV-25 | 20.5 | P.R.9 | 4.5 | 82:18 |
| 5 | IV-26 | 12.5 | P.R.9 | 12.5 | 50:50 |
| 6 | Complex | 22.5 | S.R.49 | 2.5 | 90:10 |
| | compound 1 | | | | |
| 7 | IV-25 | 7.5 | S.R.49 | 17.5 | 30:70 |
| 8 | P.R.209 | 15.0 | P.R.9 | 10.0 | 60:40 |
| 9 | P.R.122 | 22.5 | P.R.57 | 2.5 | 90:10 |
| 10 | IV-25 | 12.5 | P.R.9 | 12.5 | 50:50 |
| 11 | IV-25 | 20.5 | P.R.208 | 4.5 | 82:18 |
| 12 | IV-26 | 12.5 | P.R.209 | 12.5 | 50:50 |
| 13 | P.R.81:4 | 5.0 | P.R.208 | 20.0 | 20:80 |
| 14 | P.R.81:4 | 18.75 | P.R.48 | 6.25 | 75:25 |
| 15 | Complex | 23.75 | P.R.9 | 1.25 | 95:5 |
| | compound 2 | | | | |
| 16 | Complex | 12.5 | P.R.9 | 12.5 | 50:50 |
| | compound 1 | | | | |
| 17 | P.R.81:4 | 0.75 | P.R.209 | 24.25 | 3:97 |
| 18 | Complex | 12.5 | P.R.9 | 12.5 | 50:50 |
| | compound 2 | | | | |
| 19 | IV-25 | 25.0 | — | — | — |
| 20 | Complex | 17.5 | P.R.9 | 7.5 | 70:30 |
| | compound 1 | | | | |

P.R. = C.I. Pigment Red
S.R. = C.I. Solvent Red

2. Preparation of “cyan toner 1”
2-1. Preparation of “core forming resin particles”

“Core forming resin particles” were prepared by the following procedures.

(1) 1^{st} step polymerization

In a reaction vessel fitted with a stirrer, a thermal sensor, a cooling pipe and a nitrogen introducing device was charged a surfactant solution prepared by dissolving 4 parts by weight of an anionic surfactant represented by the following structural formula I in 3,040 parts by weight of ion-exchange water, and the internal temperature of the system was increased to 80° C. while stirring at a stirring speed of 230 rpm under nitrogen flow.

C₁₀H₂₁(OCH₂CH₂)₂SO₃Na (Structural formula 1)

Into the above-described surfactant solution was added an initiator solution prepared by dissolving 10 parts by weight of a polymerization initiator (potassium persulfate: KPS) in 400 parts by weight of ion-exchange water, and then heated up to 75° C. Then a monomer mixture solution containing the following compounds was dropped into the reaction vessel spending one hour.

| | |
|---|---|
| Styrene | 532 parts by weight |
| n-Butyl acrylate | 200 parts by weight |
| Methacrylic acid | 68 parts by weight |
| n-Octyl mercaptan | 16.4 parts by weight |

After dropping the foregoing monomer mixture solution, this system was heated at 75° C. for 2 hours, polymerization was conducted while stirring (the 1^{st} step polymerization) to prepare resin particles. These resin particles are designated as “resin particles A1”.

### (2) 2^{nd} Step Polymerization (Formation of an Intermediate Layer)

The following compounds were added into a flask fitted with a stirring device to prepare a monomer mixture solution.

| | |
|---|---|
| Styrene | 101.1 parts by weight |
| n-butyl acrylate | 62.2 parts by weight |
| Methacrylic acid | 12.3 parts by weight |
| n-octylmercaptan | 1.75 parts by weight |

Subsequently, 93.8 parts by weight of paraffin wax “HNP-57” (produced by Nippon Seiro Co., Ltd.) as a releasing agent were added into the foregoing monomer mixture solution and were dissolved via heat at 80° C. to prepare a monomer solution.

On the other hand, a surfactant solution prepared by dissolving 3 parts by weight of an anionic surfactant represented by the above-described structural formula I in 1,560 parts by weight of ion-exchange water was heated to 80° C., and 32.8 parts by weight of a dispersion of the foregoing “resin particles A1” in terms of the solid content conversion were added into this surfactant solution. After the addition, a monomer solution dissolved the foregoing releasing agent was mixed and dispersed for 8 hours by a mechanical dispersion apparatus “CLEAR MIX” (manufactured by M Technique Co.) equipped with a circulation pass to prepare a dispersion containing emulsified particles having a dispersion particle diameter of 340 nm.

Next, an initiator solution prepared by dissolving 6 parts by weight of potassium persulfate in 200 parts by weight of ion-exchange water was added into the foregoing dispersion, and this system was heated at 80° C. for 3 hours while stirring to conduct polymerization (the 2 step polymerization), and to obtain a dispersion of resin particles. These resin particles are designated as “resin particles A2”.

### (3) 3^{rd} Step Polymerization (Formation of an Outer Layer)

An initiator solution prepared by dissolving 5.45 parts by weight of potassium peroxide in 220 parts by weight of ion-exchange water was added into the resulting dispersion of “resin particles A2” as described above, and a mixture solution composed of the following compounds was dropped at 80° C. spending one hour.

| | |
|---|---|
| Styrene | 293.8 parts by weight |
| n-Butyl acrylate | 154.1 parts by weight |
| n-Octylmercaptan | 7.08 parts by weight |

After termination of dropping the foregoing monomer mixture solution, polymerization (the 3 step polymerization) was conducted by heating while stirring for 2 hours, and subsequently, the system was cooled to 28° C. to prepare “core forming resin particles A”. Glass transition temperature Tg of “core forming resin particles A” prepared via the 3^{rd} step polymerization was 28.1° C.

2-2. Preparation of “core particles 1”

In a reaction vessel fitted with a stirrer, a thermal sensor, a cooling pipe and a nitrogen introducing device, the following composition were charged with stirring.

| | | |
|---|---|---|
| Dispersion of “core formation resin particles A” | 420.7 | parts by weight |
| | | (solid content |
| | | conversion) |
| Ion-exchange water | 900 | parts by weight |
| “Cyan colorant particle dispersion 1” | 200 | parts by weight |
| | | (solid content |
| | | conversion) |

After temperature inside the vessel was adjusted to 30° C., 5 mol/litter of an aqueous sodium hydroxide solution was added into this solution to adjust the pH to 10.

Next, an aqueous solution prepared by dissolving 2 parts by weight of magnesium chloride hexahydrate in 1,000 parts by weight of ion-exchange water was added to the aforesaid mixture at 30° C. for 10 minutes while stirring. After standing for 3 minutes, elevation of temperature was started, and the temperature of this system was elevated to 65° C. spending 60 minutes. In such state, the particle diameter of associated particles was measured employing “Coulter counter TA-II” (produced by Beckman Coulter Co. Ltd), and when a volume-based median particle diameter D₅₀ reached 5.5 μm, the particle diameter increase was terminated via addition of an aqueous solution prepared by dissolving 40.2 parts by weight of sodium chloride in 1,000 parts by weight of ion-exchange water. Further, ripening was conducted at a liquid temperature of 70° C. for one hour by heating while stirring to continue the fusion, and then, “core particles 1” was formed. The circularity of obtained “core particles 1” was determined via “FPIA2100” (produced by SYSMEX Co., Ltd.), resulting in an average circularity of 0.912.

2-3. Preparation of “shell forming resin particles 1”

“Shell forming resin particles 1” were prepared in the same manner as preparing “core forming resin particles A” except that the monomer mixture solution used in the 1^{st} step polymerization was replaced with the mixture containing the compounds and the added amounts as indicated below.

| | |
|---|---|
| Styrene | 624 parts by weight |
| 2-Ethylhexyl acrylate | 120 parts by weight |
| Methacrylic acid | 56 parts by weight |
| n-Octyl mercaptan | 16.4 parts by weight |

Polymerization and after treatment were done to obtain “shell forming resin particles 1”. Glass transition temperature (Tg) of the obtained “shell forming resin particles 1” was 62.6° C.

### 2-4. Preparation of a Shell Layer

Next, 96 parts by weight of a dispersion of “shell forming resin particles 1” were added at 65° C., and an aqueous solution prepared by dissolving 2 parts by weight of magnesium chloride hexahydrate in 1,000 parts by weight of ion-exchange water was further added for 10 minutes. After the addition, the temperature was increased to 70° C. (shell forming temperature), and stirring was continued spending one hour to fuse “shell forming resin particles 1” on the surface of “core particles 1”. After this, a ripening treatment was conducted at 75° C. for 20 minutes to form a shell layer.

Herein, 40.2 parts by weight of sodium chloride were added, the system was cooled to 30° C. at a rate of 6° C./minute, the resulting colored particles were filtrated, and were washed repeatedly with ion-exchanged water at 45° C. Thereafter, drying was conducted employing 40° C. air flow to obtain “cyan toner 1” having a shell layer formed on the surface of the core particle.

### 3. Preparation of “Cyan Toners 2-13” and “Magenta Toners 1-20”

“Cyan toners 2-13” each were prepared in the same manner as preparation of “cyan toner 1” except that “cyan colorant particle dispersion 1” used for “cyan toner 1” was replaced with “cyan colorant particle dispersions 2-13” as shown in the aforesaid Table 2.

Further, “magenta toners 1-20” each were prepared in the same manner as preparation of “cyan toner 1” except that “cyan colorant particle dispersion 1” used for “cyan toner 1” was replaced with “magenta colorant particle dispersions 1-20” as shown in the aforesaid Table 3.

### 4. Preparation of Developer

### (1) Preparation of “Carrier 1”

A mixture of 100 parts by weight of toluene and 20 parts by weight of carbon black “Mogul-L” (made by Cabot Co. Ltd.) were dispersed with zirconia beads having a particle size of 0.5 mm at a room temperature for 4 hours. After dispersing treatment, the mixture was filtered to yield a carbon black dispersion.

Then, ferrite particles composed of Fe₂O₃/MnO/MgO (content ratio: 50/10/40) having an average primary particle size of 40 μm as a conductive core forming material were prepared.

Further, a coating solution was prepared as follows. To 100 parts by weight of a silicone resin (trade name: SR-2411, solid density: 20 weight %, made by Toray Dow Corning Co. Ltd.) was mixed with 10 parts by weight of a silane coupling agent (N-phenyl-γ-aminopropylmethyltrimethoxysilane). TO this mixture was added the above prepared carbon black dispersion so as to have a content of the carbon black dispersion to be 5 weight % based on the solid part of the silicone resin. Then it was dissolved in toluene to prepare a coating solution.

The above prepared coating solution was coated to the above prepared conductive core forming material (ferrite particles) in an amount of 1 weight %. Further, the coated ferrite particles were baked. After cooling them, they were treated with a vibration mill to obtain “carrier 1”.

### (2) Preparation of “Cyan Developer 1”

To 90 parts by weight of the aforesaid “carrier 1” was added 9 parts by weight of the aforesaid “cyan toner 1”. They were subjected to a mixing treatment with a V-shape mixer “V-20” (made bay Seishin Enterprise Co. Ltd.) to obtain a two-component developer “cyan developer 1”.

### (3) Preparation of “Cyan Developers 2-13” and “Magenta Developers 1-20”

“Cyan developers 2-13” and “magenta developers 1-20” were prepared in the same manner as preparation of the aforesaid “cyan developer 1” by mixing each magenta toner and cyan toner with “carrier 1”.

### 5. Evaluation Experiment

As an evaluation apparatus, it was used a commercially available full-color multifunctional peripheral machine “bizhub PRO C6500” (manufactured by Konica Minolta Business Technologies, Inc.) The developing device in this machine was modified so as to have a structure shown in FIG. 2 and FIG. 3. Each of the above prepared developers was installed in this machine. Namely, a developing device modified to a non-contact developing method as shown in FIG. 2 and a developing device modified to a hybrid developing method as shown in FIG. 3 were prepared for the developing devices used for the evaluation apparatus. “Cyan developers 1-13” and “magenta developers 1-20” each were loaded in these developing devices.

### (1) Measurement of Lightness L*_{C} of a Cyan Toner Image and a Magenta Toner Image Each Exhibiting a Maximum Chroma

“Cyan toners 1-13” each were combined with a developing device shown in FIG. 2 or FIG. 3. Each toner image exhibiting a maximum chroma with each cyan toner was produced by using the above described evaluation apparatus under the condition of a temperature of 20° C. and a humidity of 50% RH. Lightness L*_{C} of each produced image was measured.

The maximum chroma of each cyan toner image was measured in accordance with the aforesaid procedure using the amount of toner adhesion on an electrophotographic gloss paper “POD GLOSS COAT” (made of Oji Paper Co. Ltd.) having a weight of 128 g/m² and a lightness of 80. Then, the lightness L*_{C} of each cyan toner image exhibiting the maximum chroma was calculated using a spectrophotometer “Gretag Macbeth Spectrolino” (produced by Gretag Macbeth Co. Ltd.).

The maximum chroma and the lightness L*_{C} at the maximum chroma of the cyan toner image were calculated by the aforesaid procedures. As a result of the above-described evaluation, when a cyan toner image exhibited the maximum chroma, the cyan toner which produced the cyan toner image having lightness L*_{C} within the range recited in the present invention is designated as an inventive example. While, the cyan toner which produced a cyan image having lightness L*_{C} outside of the range recited in the present invention is designated as a comparative example. The maximum chroma and the lightness L*_{C} of the cyan toner image obtained by the combination of each cyan toner and each developing device are listed in Table 4 which will be described later.

The maximum chroma and the lightness L*_{M} at the maximum chroma of “magenta toners 1-20” were calculated in the same manner as the aforesaid procedure. As a result of the above-described evaluation, when a magenta toner image exhibited the maximum chroma, the magenta toner which produced the magenta toner image having lightness L*_{M} within the range recited in the present invention is designated as an inventive example. While, the magenta toner which produced a magenta image having lightness L*_{C} outside of the range recited in the present invention is designated as a comparative example. The maximum chroma and the lightness L*_{M} of the magenta toner image obtained by the combination of each magenta toner and each developing device are listed in Table 4 which will be described later.

### (2) Image Evaluation Experiment

A blue halftone image and a blue solid image were produced using a combination of the aforesaid cyan toner and the aforesaid magenta toner as indicated in Table 4 with the aforesaid evaluation apparatus under the condition of a temperature of 20° C. and a humidity of 50% RH. “Halftone image quality” and “edge portion image quality” were evaluated according to the following criteria by using the output images. Here, the evaluation of “halftone image quality” is an evaluation obtained from granularity and evenness of the image used by the aforesaid halftone image. The evaluation of “edge portion image quality” is done using the aforesaid solid image. In addition, “blue” used here indicates a hue having a hue angle of 275±2 degree. The “solid image” indicates an image having an amount of toner adhesion on the recording paper in the range of 8.0±2 g/m², and the “halftone image” indicates an image having an amount of toner adhesion on the recording paper in the range of 2.0±2 g/m² achieved by setting the condition of the evaluation apparatus.

The combinations of the cyan toner and the magenta toner used for producing the aforesaid blue halftone image and the aforesaid blue solid image are shown in Table 4. Here, the combinations which show the L*s in the range recited in the present invention when the cyan toner and the magenta toner both exhibit the maximum chroma are designated as “Inventive examples 1-18”. On the other hand, the combinations which show the L* outside the range recited in the present invention when at least one of the cyan toner and the magenta toner exhibits the maximum chroma are designated as “Comparative examples 1-10”.

### <Halftone Image Evaluation (Granularity and Evenness)>

Evaluation was made based on the following criteria. The rankings of “A” and “B” were indicated as acceptable.

### (Evaluation Criteria)

A: No granularity can be visually observed at all, and no toner particle to cause dust was observed when observation between dots was made employing a loupe at a magnification of 20 times.

B: The degree of granularity is below “A”, although no granularity can be visually observed.

C: Low resolution feeling is visually observed in comparison to an image ranked “B”, or an uncountable number of toner particles to cause dust when observation, between dots was made employing a loupe at an magnification of 20 times.

### <Edge Portion Image Evaluation (Edge Emphasis and Edge Deficit)>

Evaluation was made based on the following criteria. The rankings of “A” and “B” were indicated as acceptable.

A: No “edge emphasis”, no “edge deficit” and no “fluctuation of density at an edge portion” are detected at all

B: The degrees of “edge emphasis”, “edge deficit” and “fluctuation of density at an edge portion” are superior to the conventional electrophotographic images, however, the ranking of the total image quality is below the ranking “A”.

C: There are produced “edge emphasis” and “edge deficit” to an extent equivalent to or more than the conventional electrophotographic images

The obtained results are shown in Table 4.

TABLE 4

| | Cyan toner | | | | Magenta toner | | | | Developing | Blue image evaluation result | |
|---|---|---|---|---|---|---|---|---|---|---|---|
| | | | *2 | | | | *2 | | method | | Edge portion |
| | Toner | | | Lightness | Toner | | | Lightness | (Fig. | Halftone image | image |
| | No. | *1 | *3 | L*_{C} | No. | *1 | *3 | L*_{M} | Number) | evaluation | evaluation |
| Inv. 1 | 1 | 1 | 71 | 70 | 1 | 1 | 95 | 45 | FIG. 2 | A | A |
| Inv. 2 | 2 | 2 | 64 | 61 | 4 | 4 | 90 | 49 | FIG. 2 | A | A |
| Inv. 3 | 3 | 3 | 62 | 67 | 5 | 5 | 88 | 49 | FIG. 2 | A | B |
| Inv. 4 | 4 | 4 | 74 | 67 | 6 | 6 | 96 | 36 | FIG. 2 | B | A |
| Inv. 5 | 5 | 5 | 54 | 54 | 7 | 7 | 95 | 51 | FIG. 2 | B | A |
| Inv. 6 | 6 | 6 | 59 | 64 | 10 | 10 | 90 | 39 | FIG. 2 | A | A |
| Inv. 7 | 7 | 7 | 58 | 64 | 11 | 11 | 91 | 36 | FIG. 2 | B | A |
| Inv. 8 | 8 | 8 | 61 | 67 | 12 | 12 | 99 | 41 | FIG. 2 | A | A |
| Inv. 9 | 9 | 9 | 54 | 53 | 15 | 15 | 91 | 44 | FIG. 2 | B | A |
| Inv. 10 | 10 | 10 | 63 | 57 | 16 | 16 | 97 | 36 | FIG. 2 | B | B |
| Inv. 11 | 11 | 11 | 67 | 67 | 17 | 17 | 94 | 35 | FIG. 2 | B | A |
| Inv. 12 | 3 | 3 | 62 | 67 | 18 | 18 | 89 | 38 | FIG. 2 | A | B |
| Inv. 13 | 2 | 2 | 64 | 61 | 19 | 19 | 89 | 51 | FIG. 2 | B | A |
| Inv. 14 | 6 | 6 | 59 | 64 | 20 | 20 | 88 | 44 | FIG. 2 | A | A |
| Inv. 15 | 2 | 2 | 64 | 61 | 1 | 1 | 95 | 45 | FIG. 3 | A | A |
| Inv. 16 | 3 | 3 | 62 | 67 | 4 | 4 | 90 | 49 | FIG. 3 | A | A |
| Inv. 17 | 9 | 9 | 54 | 53 | 12 | 12 | 99 | 41 | FIG. 3 | A | A |
| Inv. 18 | 2 | 2 | 64 | 61 | 15 | 15 | 91 | 44 | FIG. 3 | A | A |
| Comp. 1 | 12 | 12 | 63 | 49 | 2 | 2 | 50 | 21 | FIG. 2 | C | C |
| Comp. 2 | 13 | 13 | 66 | 52 | 3 | 3 | 52 | 15 | FIG. 2 | C | C |
| Comp. 3 | 12 | 12 | 63 | 49 | 8 | 8 | 101 | 24 | FIG. 2 | C | C |
| Comp. 4 | 13 | 13 | 66 | 52 | 9 | 9 | 92 | 20 | FIG. 2 | C | C |
| Comp. 5 | 12 | 12 | 63 | 49 | 13 | 13 | 55 | 28 | FIG. 2 | C | C |
| Comp. 6 | 13 | 13 | 66 | 52 | 14 | 14 | 51 | 33 | FIG. 2 | C | C |
| Comp. 7 | 2 | 2 | 64 | 61 | 1 | 1 | 95 | 45 | ** | C | C |
| Comp. 8 | 3 | 3 | 62 | 67 | 4 | 4 | 90 | 49 | ** | C | C |
| Comp. 9 | 9 | 9 | 54 | 53 | 12 | 12 | 99 | 41 | ** | C | C |
| Comp. 10 | 2 | 2 | 64 | 61 | 15 | 15 | 91 | 44 | ** | C | C |

*1: Colorant particle dispersion No.,
*2: Maximum chroma and Lightness,
*3: Maximum chroma value
Inv.: Inventive examples,
Comp.: Comparative example,
**: Contact developing method

As are shown in Table 4, “Inventive examples 1-18” which were produced using the cyan toner and the magenta toner both of which satisfied the requirements of the present invention exhibited an excellent results of both halftone image quality and edge portion image quality in a blue image. On the other hand, “Comparative examples 1-10” which were produced using at least one of the cyan toner and the magenta toner which did not satisfy the requirements of the present invention exhibited failed to exhibit excellent results of both halftone image quality and edge portion image quality. As demonstrated by these results obtained from the afore-mentioned evaluations, there is a distinguished difference of image quality between the image produced with the cyan toner satisfying the requirements of the present invention and the image produced the cyan toner not satisfying the requirements of the present invention.

What is claimed is:

1. A method for manufacturing a color print by an electrophotographic image forming process comprising the steps of:
forming a cyan toner image by non-contact developing a 1st electrostatic latent image on a 1st electrostatic latent image holding member with a cyan toner contained in a 1st developing device,
forming a magenta toner image by non-contact developing a 2nd electrostatic latent image on a 2nd electrostatic latent image holding member with a magenta toner contained in a 2nd developing device and,
forming a yellow toner image by non-contact developing a 3rd electrostatic latent image on a 3rd electrostatic latent image holding member with a yellow toner contained in a 3rd developing device,
wherein each of the developing devices has a toner holding member arranged in a non-contact position with each of the electrostatic latent image holding members at a development portion,
the non-contact developing is carried out by supplying the toner held on the toner holding member to the electrostatic latent image holding member with flying and,
the cyan toner satisfies the following condition that a cyan image formed with only the cyan toner exhibits a maximum chroma at lightness L*_{C} of from 53-70.

2. The method for manufacturing a color print of claim 1,
wherein the magenta toner satisfies the following condition that a magenta image formed with only the magenta toner exhibits a maximum chroma at lightness L*_{M} of from 35-51.

3. The method for manufacturing a color print of claim 1,
wherein the non-contact developing method is a hybrid developing method.

4. The method for manufacturing a color print of claim 1,
wherein the cyan toner contains at least one of a compound represented by Formula (I) and a compound represented by Formula (II): 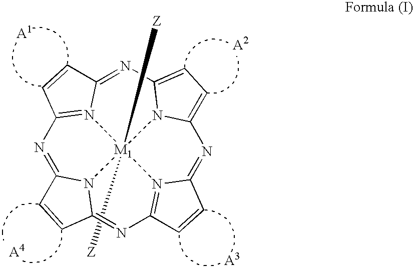
wherein M¹ represents a center metal atom selected from the group consisting of Si, Ge and Sn; two Zs each independently represents a hydroxyl group, a chlorine atom, an aryloxy group having 6-18 carbon atoms, an alkoxy group having 1-22 carbon atoms or a group represented by Formula (1); and A¹, A², A³ and A⁴ each independently represent an atomic group represented by one of (a-1) to (1-18), each forming an aromatic ring which may have an electron-withdrawing group on the aromatic ring, 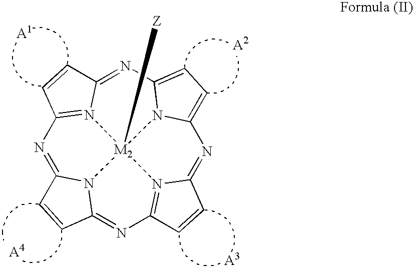
wherein M² represents a center metal atom of Al or Ga. Z represents a hydroxyl group, a chlorine atom, an aryloxy group having 6-18 carbon atoms, an alkoxy group having 1-22 carbon atoms or a group represented by Formula (1); and A¹, A², A³ and A⁴ each independently represent an atomic group represented by one of (a-1) to (1-18), each forming an aromatic ring which may have an electron-withdrawing group on the aromatic ring, 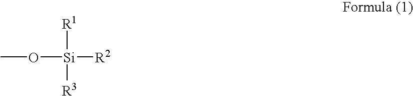
wherein R₁, R₂ and R₃ each represent an alkyl group having 1-22 carbon atoms, an aryl group having 6-18 carbon atoms, an alkoxy group having 1-22 carbon atoms or an aryloxy group having 6-18 carbon atoms, R₁, R₂ and R₃ may be identical with each other, or may be different from each other,

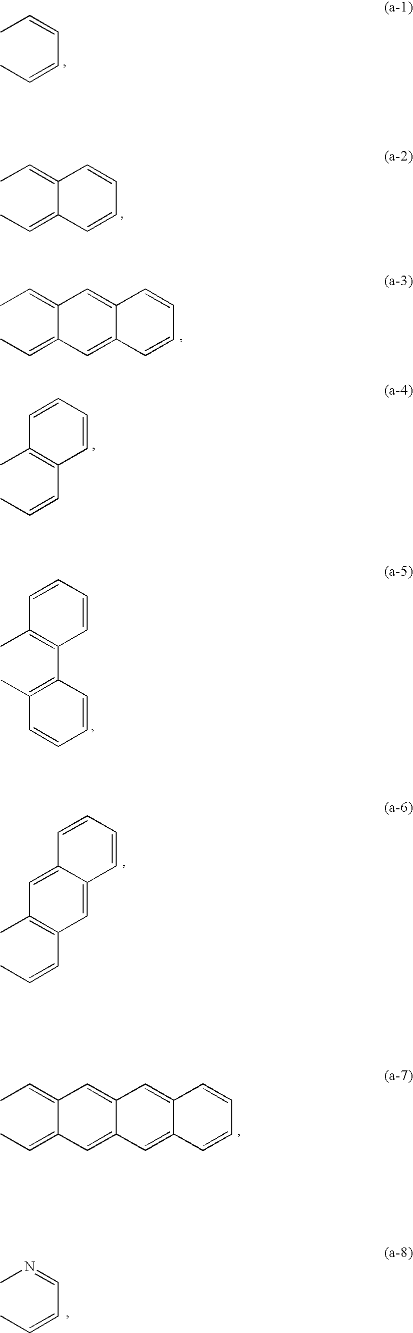

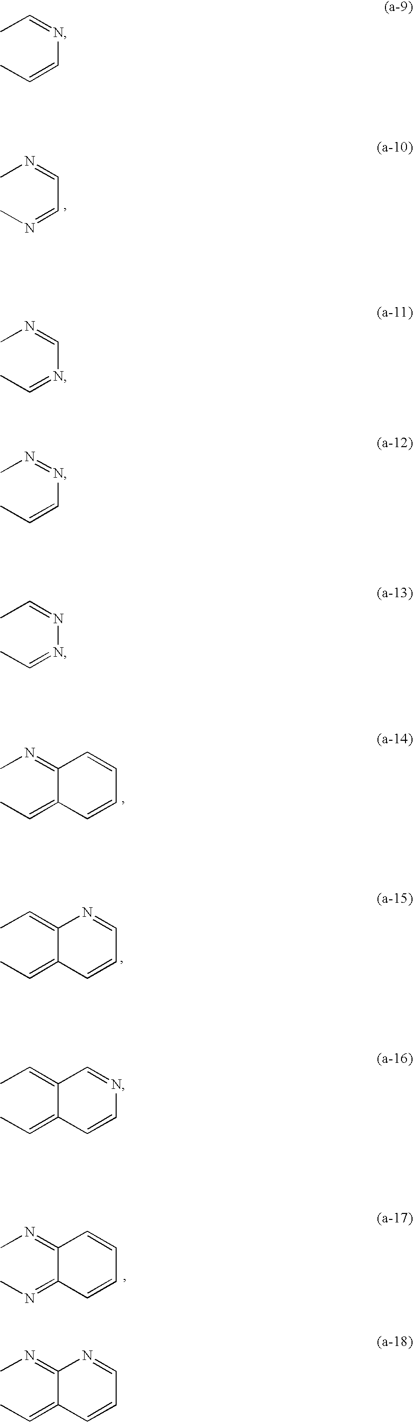

5. The method for manufacturing a color print of claim 4,
wherein the cyan toner further contains a compound represented by Formula (III): 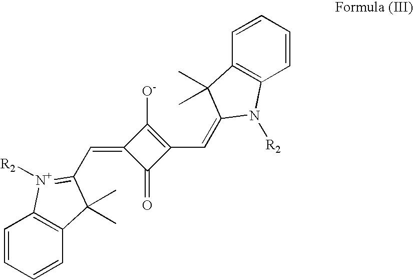
wherein R₂ represents a hydrogen atom or an organic group.

6. The method for manufacturing a color print of claim 1, further comprising the steps of:
primary transferring the cyan toner image, the magenta toner image and the yellow toner image to an intermediate transfer material to form a color toner image,
secondary transferring the color toner image to a recording material and,
fixing the color toner image on the recording material.
